(19) United States
(12) Patent Application Publication
(10) Pub. No.: US 2025/0220230 A1
(43) Pub. Date: Jul. 3, 2025

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG Electronics Inc., Seoul (KR)

(72) Inventors: Yousun PARK, Seoul (KR); Hyejung HUR, Seoul (KR); Sooyeon LEE, Seoul (KR)

(21) Appl. No.: 18/852,912

(22) PCT Filed: Mar. 29, 2023
(86) PCT No.: PCT/KR2023/004155

§ 371 Date: Sep. 30, 2024

(30) Foreign Application Priority Data
Mar. 31, 2022 (KR) 10-2022-0040046
Nov. 2, 2022 (KR) 10-2022-0144250

(51) Int. Cl. H04N 19/597; H04N 19/70; H04N 19/96

(52) U.S. Cl. CPC H04N 19/597; H04N 19/70; H04N 19/96

(57) ABSTRACT

A point cloud data transmission method according to embodiments may comprise the steps of: encoding point cloud data; and transmitting a bitstream comprising the point cloud data. In addition, a point cloud data transmission device according to embodiments may comprise: an encoder which encodes point cloud data; and a transmitter which transmits a bitstream comprising the point cloud data.

### TECHNICAL FIELD

Embodiments relate to a method and device for processing point cloud content.

### BACKGROUND ART

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), and self-driving services. However, tens of thousands to hundreds of thousands of point data are required to represent point cloud content. Therefore, there is a need for a method for efficiently processing a large amount of point data.

### DISCLOSURE

### Technical Problem

Embodiments provide a device and method for efficiently processing point cloud data. Embodiments provide a point cloud data processing method and device for addressing latency and encoding/decoding complexity.

The technical scope of the embodiments is not limited to the aforementioned technical objects, and may be extended to other technical objects that may be inferred by those skilled in the art based on the entire contents disclosed herein.

### Technical Solution

To achieve these objects and other advantages and in accordance with the purpose of the disclosure, provided herein are a point cloud data transmission device, a point cloud data transmission method, a point cloud data reception device, and a point cloud data reception method for efficiently transmitting and receiving a point cloud.

In another aspect of the present disclosure, provided herein are a point cloud data transmission device, a point cloud data transmission method, a point cloud data reception device, and a point cloud data reception method for addressing latency and encoding/decoding complexity.

Embodiments are not limited to the above-described objects, and the scope of the embodiments may be extended to other objects that can be inferred by those skilled in the art based on the entire contents of the present disclosure.

### Advantageous Effects

Devices and methods according to embodiments may process point cloud data with high efficiency.

The devices and methods according to the embodiments may provide a high-quality point cloud service.

The devices and methods according to the embodiments may provide point cloud content for providing general-purpose services such as a VR service and a self-driving service.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts.

FIG. 1 shows an exemplary point cloud content providing system according to embodiments;

FIG. 2 is a block diagram illustrating a point cloud content providing operation according to embodiments;

FIG. 3 illustrates an exemplary point cloud encoder according to embodiments;

FIG. 4 shows an example of an octree and occupancy code according to embodiments;

FIG. 5 illustrates an example of point configuration in each LOD according to embodiments;

FIG. 6 illustrates an example of point configuration in each LOD according to embodiments;

FIG. 7 illustrates a point cloud decoder according to embodiments;

FIG. 8 illustrates a transmission device according to embodiments;

FIG. 9 illustrates a reception device according to embodiments;

FIG. 10 illustrates an exemplary structure operable in connection with point cloud data transmission/reception methods/devices according to embodiments;

FIG. 11 illustrates a method of generating and encoding a predictive tree structure according to embodiments;

FIG. 12 illustrates inter-frame prediction according to embodiments;

FIG. 13 illustrates point cloud data presented in a coordinate system according to embodiments;

FIG. 14 illustrates point cloud data according to embodiments;

FIG. 15 illustrates point cloud data according to embodiments;

FIG. 16 illustrates a point cloud data transmission device according to embodiments;

FIG. 17 illustrates a point cloud data reception device according to embodiments;

FIG. 18 illustrates an encoded bitstream according to embodiments;

FIG. 19 illustrates a syntax of a sequence parameter set (seq_parameter_set) according to embodiments;

FIG. 20 illustrates a syntax of a tile parameter set (tile_parameter_set) according to embodiments;

FIG. 21 illustrates a syntax of a geometry parameter set (geometry_parameter_set) according to embodiments;

FIG. 22 illustrates a syntax of an attribute parameter set (attribute_parameter_set) according to embodiments;

FIG. 23 illustrates a syntax of a geometry slice header (geometry_slice_header) according to embodiments;

FIG. 24 illustrates a transmission method according to embodiments; and

FIG. 25 illustrates a reception method according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

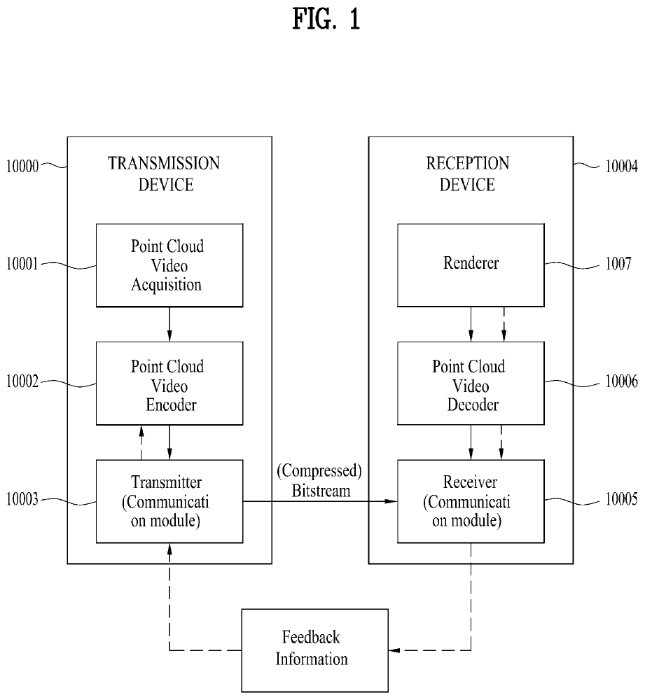

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquirer 10001, a point cloud video encoder 10002, and/or a transmitter (or communication module) 10003.

The point cloud video acquirer 10001 according to the embodiments acquires a point cloud video through a processing process such as capture, synthesis, or generation. The point cloud video is point cloud content represented by a point cloud, which is a set of points positioned in a 3D space, and may be referred to as point cloud video data, point cloud data, or the like. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the reverse process to the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video data decoder 10006 may perform a decoding operation based on the feedback information. The reception device 10004 may transmit the feedback information to the transmission device 10000. The transmission device 10000 (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, or the like, and the reception device 10004 may be called a decoder, a receiving device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

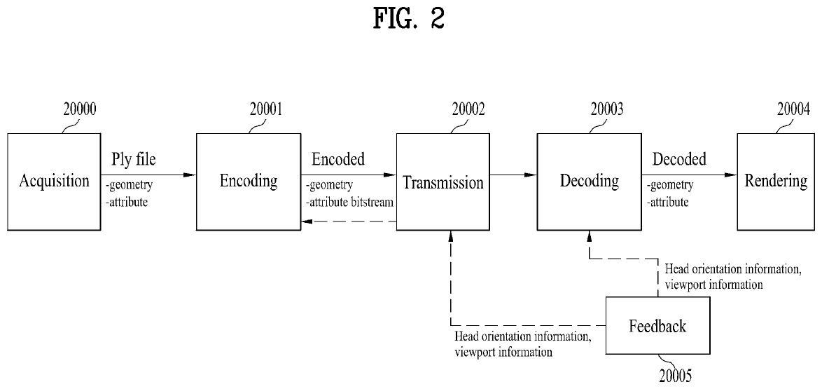

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (e.g., the point cloud transmission device 10000 or the point cloud video acquirer 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, position information, position data, or the like, and the attribute may be called attributes, attribute information, attribute data, or the like. The point cloud content providing system (e.g., the point cloud transmission device 10000 or the point cloud video acquirer 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry information and attribute information about a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

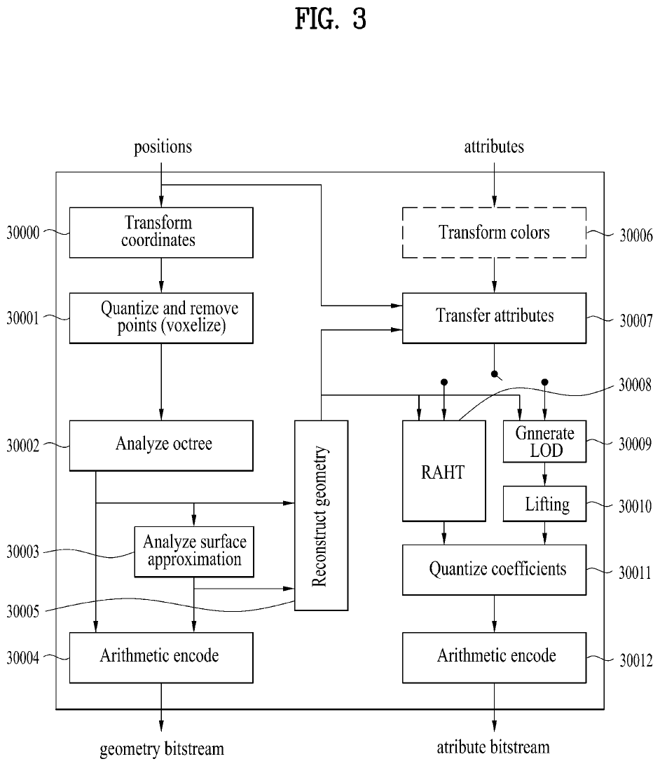

FIG. 3 illustrates an exemplary point cloud encoder according to embodiments.

FIG. 3 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud encoder according to the embodiments includes a coordinate transformer (Transform coordinates) 30000, a quantizer (Quantize and remove points (voxelize)) 30001, an octree analyzer (Analyze octree) 30002, and a surface approximation analyzer (Analyze surface approximation) 30003, an arithmetic encoder (Arithmetic encode) 30004, a geometry reconstructor (Reconstruct geometry) 30005, a color transformer (Transform colors) 30006, an attribute transformer (Transform attributes) 30007, a RAHT transformer (RAHT) 30008, an LOD generator (Generate LOD) 30009, a lifting transformer (Lifting) 30010, a coefficient quantizer (Quantize coefficients) 30011, and/or an arithmetic encoder (Arithmetic encode) 30012.

The coordinate transformer 30000, the quantizer 30001, the octree analyzer 30002, the surface approximation analyzer 30003, the arithmetic encoder 30004, and the geometry reconstructor 30005 may perform geometry encoding. The geometry encoding according to the embodiments may include octree geometry coding, predictive tree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 30000 according to the embodiments receives positions and transforms the same into coordinates. For example, the positions may be transformed into position information in a three-dimensional space (e.g., a three-dimensional space represented by an XYZ coordinate system). The position information in the three-dimensional space according to the embodiments may be referred to as geometry information.

The quantizer 30001 according to the embodiments quantizes the geometry. For example, the quantizer 30001 may quantize the points based on a minimum position value of all points (e.g., a minimum value on each of the X, Y, and Z axes). The quantizer 30001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 30001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 30001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 30002 according to the embodiments performs octree geometry coding (or octree coding) to present voxels in an octree structure. The octree structure represents points matched with voxels, based on the octal tree structure.

The surface approximation analyzer 30003 according to the embodiments may analyze and approximate the octree. The octree analysis and approximation according to the embodiments is a process of analyzing a region containing a plurality of points to efficiently provide octree and voxelization.

The arithmetic encoder 30004 according to the embodiments performs entropy encoding on the octree and/or the approximated octree. For example, the encoding scheme includes arithmetic encoding. As a result of the encoding, a geometry bitstream is generated.

The color transformer 30006, the attribute transformer 30007, the RAHT transformer 30008, the LOD generator 30009, the lifting transformer 30010, the coefficient quantizer 30011, and/or the arithmetic encoder 30012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 30006 according to the embodiments performs color transform coding of transforming color values (or textures) included in the attributes. For example, the color transformer 30006 may transform the format of color information (for example, from RGB to YCbCr). The operation of the color transformer 30006 according to embodiments may be optionally applied according to the color values included in the attributes.

The geometry reconstructor 30005 according to the embodiments reconstructs (decompresses) the octree and/or the approximated octree. The geometry reconstructor 30005 reconstructs the octree/voxels based on the result of analyzing the distribution of points. The reconstructed octree/voxels may be referred to as reconstructed geometry (restored geometry).

The attribute transformer 30007 according to the embodiments performs attribute transformation to transform the attributes based on the reconstructed geometry and/or the positions on which geometry encoding is not performed. As described above, since the attributes are dependent on the geometry, the attribute transformer 30007 may transform the attributes based on the reconstructed geometry information. For example, based on the position value of a point included in a voxel, the attribute transformer 30007 may transform the attribute of the point at the position. As described above, when the position of the center of a voxel is set based on the positions of one or more points included in the voxel, the attribute transformer 30007 transforms the attributes of the one or more points. When the trisoup geometry encoding is performed, the attribute transformer 30007 may transform the attributes based on the trisoup geometry encoding.

The attribute transformer 30007 may perform the attribute transformation by calculating the average of attributes or attribute values of neighboring points (e.g., color or reflectance of each point) within a specific position/radius from the position (or position value) of the center of each voxel. The attribute transformer 30007 may apply a weight according to the distance from the center to each point in calculating the average. Accordingly, each voxel has a position and a calculated attribute (or attribute value).

The attribute transformer 30007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 30007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 30009.

The RAHT transformer 30008 according to the embodiments performs RAHT coding for predicting attribute information based on the reconstructed geometry information. For example, the RAHT transformer 30008 may predict attribute information of a node at a higher level in the octree based on the attribute information associated with a node at a lower level in the octree.

The LOD generator 30009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 30010 according to the embodiments performs lifting transform coding of transforming the attributes a point cloud based on weights. As described above, lifting transform coding may be optionally applied.

The coefficient quantizer 30011 according to the embodiments quantizes the attribute-coded attributes based on coefficients.

The arithmetic encoder 30012 according to the embodiments encodes the quantized attributes based on arithmetic coding.

Although not shown in the figure, the elements of the point cloud encoder of FIG. 3 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 3 described above. Additionally, the one or more processors may operate or execute a set of software programs and/or instructions for performing the operations and/or functions of the elements of the point cloud encoder of FIG. 3. The one or more memories according to the embodiments may include a high speed random access memory, or include a non-volatile memory (e.g., one or more magnetic disk storage devices, flash memory devices, or other non-volatile solid-state memory devices).

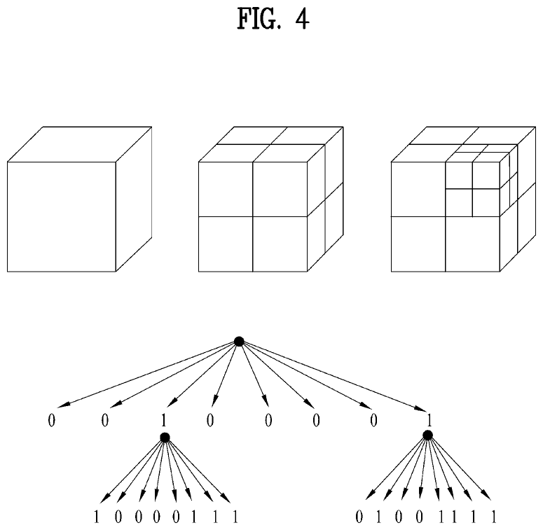

FIG. 4 shows an example of an octree and occupancy code according to embodiments.

As described with reference to FIGS. 1 to 3, the point cloud content providing system (point cloud video encoder 10002) or the point cloud encoder (e.g., the octree analyzer 30002) performs octree geometry coding (or octree coding) based on an octree structure to efficiently manage the region and/or position of the voxel.

The upper part of FIG. 4 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2^{d} may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

$$d = Ceil ( Log 2 ( Max ( {x}_{n}^{int} , {y}_{n}^{int} , {z}_{n}^{in} , n = 1 , … , N ) + 1 ) )$$

As shown in the middle of the upper part of FIG. 4, the entire 3D space may be divided into eight spaces according to partition. Each divided space is represented by a cube with six faces. As shown in the upper right of FIG. 4, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 4 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 4 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (e.g., the arithmetic encoder 30004) according to the embodiments may perform entropy encoding on the occupancy codes. In order to increase the compression efficiency, the point cloud encoder may perform intra/inter-coding on the occupancy codes. The reception device (e.g., the reception device 10004 or the point cloud video decoder 10006) according to the embodiments reconstructs the octree based on the occupancy codes.

The point cloud encoder (e.g., the point cloud encoder of FIG. 4 or the octree analyzer 30002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 30004) according to the embodiments may perform entropy coding on the positions (or position values) of the points.

The point cloud encoder (e.g., the surface approximation analyzer 30003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud encoder according to the embodiments (e.g., the geometry reconstructor 30005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: i) calculating the centroid value of each vertex, ii) subtracting the center value from each vertex value, and iii) estimating the sum of the squares of the values obtained by the subtraction.

$$[ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] ; \qquad i )$$

$$[ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] ; \qquad ii )$$

$$[ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ] \qquad iii )$$

The minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through atan2(bi, ai), and the vertices are ordered based on the value of θ. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

Triangles formed from vertices ordered 1, . . . ,n
n triangles
3 (1,2,3)
4 (1,2,3), (3,4,1)
5 (1,2,3), (3,4,5), (5,1,3)
6 (1,2,3), (3,4,5), (5,6,1), (1,3,5)
7 (1,2,3), (3,4,5), (5,6,7), (7,1,3), (3,5,7)
8 (1,2,3), (3,4,5), (5,6,7), (7,8,1), (1,3,5), (5,7,1)
9 (1,2,3), (3,4,5), (5,6,7), (7,8,9), (9,1,3), (3,5,7), (7,9,3)
10 (1,2,3), (3,4,5), (5,6,7), (7,8,9), (9,10,1), (1,3,5), (5,7,9), (9,1,5)
11 (1,2,3), (3,4,5), (5,6,7), (7,8,9), (9,10,11), (11,1,3), (3,5,7), (7,9,11), (11,3,7)
12 (1,2,3), (3,4,5), (5,6,7), (7,8,9), (9,10,11), (11,12,1), (1,3,5), (5,7,9), (9,11,1), (1,5,9)

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

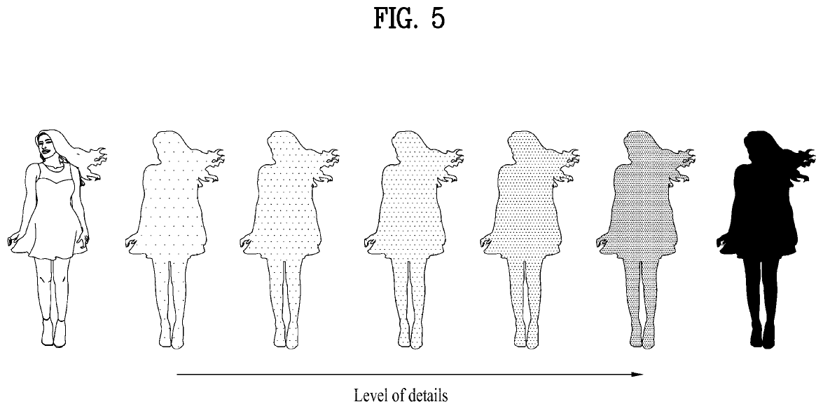

FIG. 5 illustrates an example of point configuration in each LOD according to embodiments.

As described with reference to FIGS. 1 to 4, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (e.g., the LOD generator 30009) may classify (or reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

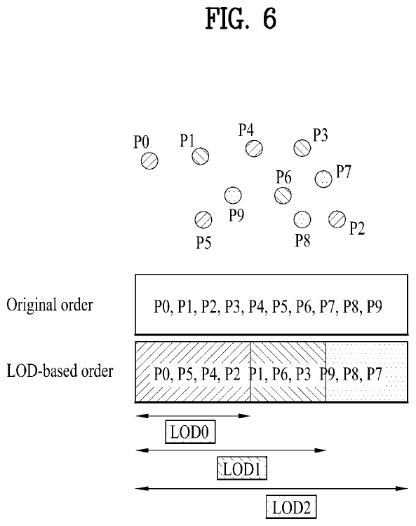

FIG. 6 illustrates an example of point configuration for each LOD according to embodiments.

As described with reference to FIGS. 1 to 5, the point cloud content providing system, or the point cloud encoder (e.g., the point cloud video encoder 10002, the point cloud encoder of FIG. 3, or the LOD generator 30009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 6 shows examples (P0 to P9) of points of the point cloud content distributed in a 3D space. In FIG. 6, the original order represents the order of points P0 to P9 before LOD generation. In FIG. 6, the LOD based order represents the order of points according to the LOD generation. Points are reorganized by LOD. Also, a high LOD contains the points belonging to lower LODs. As shown in FIG. 6, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 3, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (e.g., the coefficient quantizer 30011) may quantize and inversely quantize the residuals (which may be called residual attributes, residual attribute values, or attribute prediction residuals, attribute residuals) obtained by subtracting a predicted attribute (attribute value) from the attribute (attribute value) of each point. The quantization process is configured as shown in the following table.

TABLE 1
Attribute prediction residuals quantization pseudo code

int PCCQuantization(int value, int quantStep) {
if( value >=0) {
return floor(value / quantStep + 1.0 / 3.0);
} else {
return −floor(−value / quantStep + 1.0 / 3.0);
}
}

TABLE 2
Attribute prediction residuals inverse quantization pseudo code

int PCCInverseQuantization(int value, int quantStep) {
if( quantStep ==0) {
return value;
} else {
return value * quantStep;
}
}

When the predictor of each point has neighbor points, the point cloud encoder (e.g., the arithmetic encoder 30012) according to the embodiments may perform entropy coding on the quantized and inversely quantized residual values as described above. When the predictor of each point has no neighbor point, the point cloud encoder according to the embodiments (e.g., the arithmetic encoder 30012) may perform entropy coding on the attributes of the corresponding point without performing the above-described operation.

The point cloud encoder according to the embodiments (e.g., the lifting transformer 30010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.
1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.
2) Lift prediction process: Subtract the value obtained by multiplying the attribute value of the point by the weight from the existing attribute value to calculate a predicted attribute value.
3) Create temporary arrays called updateweight and update and initialize the temporary arrays to zero.
4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.
5) Lift update process: Divide the attribute values of the update array for all predictors by the weight value of the updateweight array of the predictor index, and add the existing attribute value to the values obtained by the division.
6) Calculate predicted attributes by multiplying the attribute values updated through the lift update process by the weight updated through the lift prediction process (stored in the QW) for all predictors. The point cloud encoder (e.g., coefficient quantizer 30011) according to the embodiments quantizes the predicted attribute values. In addition, the point cloud encoder (e.g., the arithmetic encoder 30012) performs entropy coding on the quantized attribute values.

The point cloud encoder (for example, the RAHT transformer 30008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,yz}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {h}_{{l}_{2 x + 1 , y , z}}\end{matrix} ⌉ ,$$

$${T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (e.g., encoding by the arithmetic encoder 300012). The weights are calculated as wₗ_{_{−1x,y,z}}=wₗ_{_{2x,y,z}}+wₗ_{_{2x+1,y,z}}. The root node is created through the g₁_{_{0,0,0}} and g₁_{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

FIG. 7 illustrates a point cloud decoder according to embodiments.

The point cloud decoder illustrated in FIG. 7 is an example of the point cloud decoder and may perform a decoding operation, which is a reverse process to the encoding operation of the point cloud encoder illustrated in FIGS. 1 to 6.

As described with reference to FIGS. 1 and 6, the point cloud decoder may perform geometry decoding and attribute decoding. The geometry decoding is performed before the attribute decoding.

The point cloud decoder according to the embodiments includes an arithmetic decoder (Arithmetic decode) 7000, an octree synthesizer (Synthesize octree) 7001, a surface approximation synthesizer (Synthesize surface approximation) 7002, and a geometry reconstructor (Reconstruct geometry) 7003, a coordinate inverse transformer (Inverse transform coordinates) 7004, an arithmetic decoder (Arithmetic decode) 7005, an inverse quantizer (Inverse quantize) 7006, a RAHT transformer 7007, an LOD generator (Generate LOD) 7008, an inverse lifter (inverse lifting) 7009, and/or a color inverse transformer (Inverse transform colors) 7010.

The arithmetic decoder 7000, the octree synthesizer 7001, the surface approximation synthesizer 7002, and the geometry reconstructor 7003, and the coordinate inverse transformer 7004 may perform geometry decoding. The geometry decoding according to the embodiments may include direct decoding and trisoup geometry decoding. The direct coding and trisoup geometry decoding are selectively applied. The geometry decoding is not limited to the above-described example, and is performed as a reverse process to the geometry encoding described with reference to FIGS. 1 to 6.

The arithmetic decoder 7000 according to the embodiments decodes the received geometry bitstream based on the arithmetic coding. The operation of the arithmetic decoder 7000 corresponds to the reverse process to the arithmetic encoder 30004.

The octree synthesizer 7001 according to the embodiments may generate an octree by acquiring an occupancy code from the decoded geometry bitstream (or information on the geometry secured as a result of decoding). The occupancy code is configured as described in detail with reference to FIGS. 1 to 6.

When the trisoup geometry encoding is applied, the surface approximation synthesizer 7002 according to the embodiments may synthesize a surface based on the decoded geometry and/or the generated octree.

The geometry reconstructor 7003 according to the embodiments may regenerate geometry based on the surface and/or the decoded geometry. As described with reference to FIGS. 1 to 9, direct coding and trisoup geometry encoding are selectively applied. Accordingly, the geometry reconstructor 7003 directly imports and adds position information about the points to which direct coding is applied. When the trisoup geometry encoding is applied, the geometry reconstructor 7003 may reconstruct the geometry by performing the reconstruction operations of the geometry reconstructor 30005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 7004 according to the embodiments may acquire positions of the points by transforming the coordinates based on the reconstructed geometry.

The arithmetic decoder 7005, the inverse quantizer 7006, the RAHT transformer 7007, the LOD generator 7008, the inverse lifter 7009, and/or the color inverse transformer 7010 may perform the attribute decoding described with reference to FIG. 6. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 7005 according to the embodiments decodes the attribute bitstream by arithmetic coding.

The inverse quantizer 7006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 7007, the LOD generator 7008, and/or the inverse lifter 7009 may process the reconstructed geometry and the inversely quantized attributes. As described above, the RAHT transformer 7007, the LOD generator 7008, and/or the inverse lifter 7009 may selectively perform a decoding operation corresponding to the encoding of the point cloud encoder.

The color inverse transformer 7010 according to the embodiments performs inverse transform coding to inversely transform a color value (or texture) included in the decoded attributes. The operation of the color inverse transformer 7010 may be selectively performed based on the operation of the color transformer 30006 of the point cloud encoder.

Although not shown in the figure, the elements of the point cloud decoder of FIG. 7 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 7 described above. Additionally, the one or more processors may operate or execute a set of software programs and/or instructions for performing the operations and/or functions of the elements of the point cloud decoder of FIG. 7.

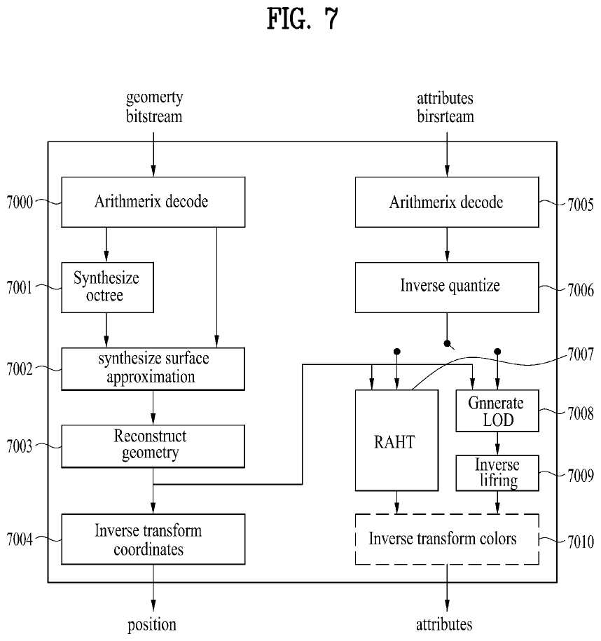

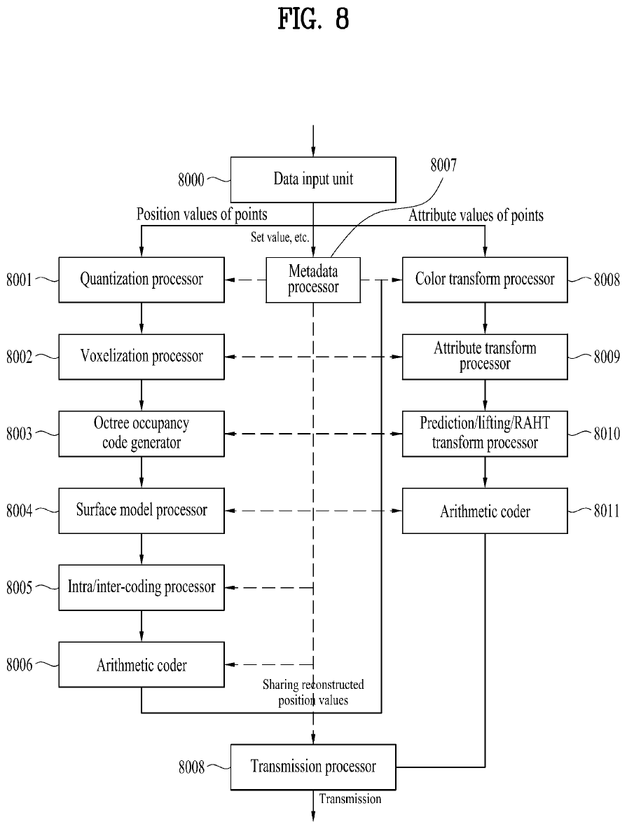

FIG. 8 illustrates a transmission device according to embodiments.

The transmission device shown in FIG. 8 is an example of the transmission device 10000 of FIG. 1 (or the point cloud encoder of FIG. 3). The transmission device illustrated in FIG. 8 may perform one or more of the operations and methods the same as or similar to those of the point cloud encoder described with reference to FIGS. 1 to 6. The transmission device according to the embodiments may include a data input unit 8000, a quantization processor 8001, a voxelization processor 8002, an octree occupancy code generator 8003, a surface model processor 8004, an intra/inter-coding processor 8005, an arithmetic coder 8006, a metadata processor 8007, a color transform processor 8008, an attribute transform processor 8009, a prediction/lifting/RAHT transform processor 8010, an arithmetic coder 8011 and/or a transmission processor 8012.

The data input unit 8000 according to the embodiments receives or acquires point cloud data. The data input unit 8000 may perform an operation and/or acquisition method the same as or similar to the operation and/or acquisition method of the point cloud video acquirer 10001 (or the acquisition process 20000 described with reference to FIG. 2).

The data input unit 8000, the quantization processor 8001, the voxelization processor 8002, the octree occupancy code generator 8003, the surface model processor 8004, the intra/inter-coding processor 8005, and the arithmetic coder 8006 perform geometry encoding. The geometry encoding according to the embodiments is the same as or similar to the geometry encoding described with reference to FIGS. 1 to 9, and thus a detailed description thereof is omitted.

The quantization processor 8001 according to the embodiments quantizes geometry (e.g., position values of points). The operation and/or quantization of the quantization processor 8001 is the same as or similar to the operation and/or quantization of the quantizer 30001 described with reference to FIG. 3. Details are the same as those described with reference to FIGS. 1 to 9.

The voxelization processor 8002 according to the embodiments voxelizes the quantized position values of the points. The voxelization processor 8002 may perform an operation and/or process the same or similar to the operation and/or the voxelization process of the quantizer 30001 described with reference to FIG. 3. Details are the same as those described with reference to FIGS. 1 to 6.

The octree occupancy code generator 8003 according to the embodiments performs octree coding on the voxelized positions of the points based on an octree structure. The octree occupancy code generator 8003 may generate an occupancy code. The octree occupancy code generator 8003 may perform an operation and/or method the same as or similar to the operation and/or method of the point cloud encoder (or the octree analyzer 30002) described with reference to FIGS. 3 and 4. Details are the same as those described with reference to FIGS. 1 to 6.

The surface model processor 8004 according to the embodiments may perform trisoup geometry encoding based on a surface model to reconstruct the positions of points in a specific region (or node) on a voxel basis. The surface model processor 8004 may perform an operation and/or method the same as or similar to the operation and/or method of the point cloud encoder (e.g., the surface approximation analyzer 30003) described with reference to FIG. 3. Details are the same as those described with reference to FIGS. 1 to 6.

The intra/inter-coding processor 8005 according to the embodiments may perform intra/inter-coding on point cloud data. The intra/inter-coding processor 8005 may perform coding the same as or similar to the intra/inter-coding described with reference to FIG. 7. Details are the same as those described with reference to FIG. 7. According to embodiments, the intra/inter-coding processor 8005 may be included in the arithmetic coder 8006.

The arithmetic coder 8006 according to the embodiments performs entropy encoding on an octree of the point cloud data and/or an approximated octree. For example, the encoding scheme includes arithmetic encoding. The arithmetic coder 8006 performs an operation and/or method the same as or similar to the operation and/or method of the arithmetic encoder 30004.

The metadata processor 8007 according to the embodiments processes metadata about the point cloud data, for example, a set value, and provides the same to a necessary processing process such as geometry encoding and/or attribute encoding. Also, the metadata processor 8007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 8008, the attribute transform processor 8009, the prediction/lifting/RAHT transform processor 8010, and the arithmetic coder 8011 perform the attribute encoding. The attribute encoding according to the embodiments is the same as or similar to the attribute encoding described with reference to FIGS. 1 to 6, and thus a detailed description thereof is omitted.

The color transform processor 8008 according to the embodiments performs color transform coding to transform color values included in attributes. The color transform processor 8008 may perform color transform coding based on the reconstructed geometry. The reconstructed geometry is the same as described with reference to FIGS. 1 to 9. Also, it performs an operation and/or method the same as or similar to the operation and/or method of the color transformer 30006 described with reference to FIG. 3 is performed. A detailed description thereof is omitted.

The attribute transform processor 8009 according to the embodiments performs attribute transformation to transform the attributes based on the reconstructed geometry and/or the positions on which geometry encoding is not performed. The attribute transform processor 8009 performs an operation and/or method the same as or similar to the operation and/or method of the attribute transformer 30007 described with reference to FIG. 3. A detailed description thereof is omitted. The prediction/lifting/RAHT transform processor 8010 according to the embodiments may code the transformed attributes by any one or a combination of RAHT coding, prediction transform coding, and lifting transform coding. The prediction/lifting/RAHT transform processor 8010 performs at least one of the operations the same as or similar to the operations of the RAHT transformer 30008, the LOD generator 30009, and the lifting transformer 30010 described with reference to FIG. 3. In addition, the prediction transform coding, the lifting transform coding, and the RAHT transform coding are the same as those described with reference to FIGS. 1 to 9, and thus a detailed description thereof is omitted.

The arithmetic coder 8011 according to the embodiments may encode the coded attributes based on the arithmetic coding. The arithmetic coder 8011 performs an operation and/or method the same as or similar to the operation and/or method of the arithmetic encoder 300012.

The transmission processor 8012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom0⁰ and one or more attribute bitstreams Attr0⁰ and Attr1⁰.

A slice refers to a series of syntax elements representing the entirety or part of a coded point cloud frame.

The TPS according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 8007 according to the embodiments may generate and/or process the signaling information and transmit the same to the transmission processor 8012. According to embodiments, the elements to perform geometry encoding and the elements to perform attribute encoding may share data/information with each other as indicated by dotted lines. The transmission processor 8012 according to the embodiments may perform an operation and/or transmission method the same as or similar to the operation and/or transmission method of the transmitter 10003. Details are the same as those described with reference to FIGS. 1 and 2, and thus a description thereof is omitted.

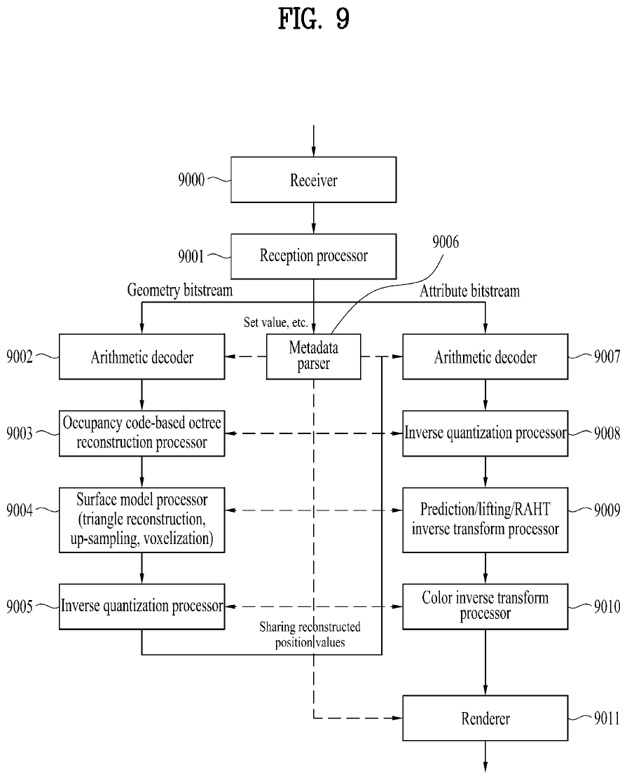

FIG. 9 illustrates a reception device according to embodiments.

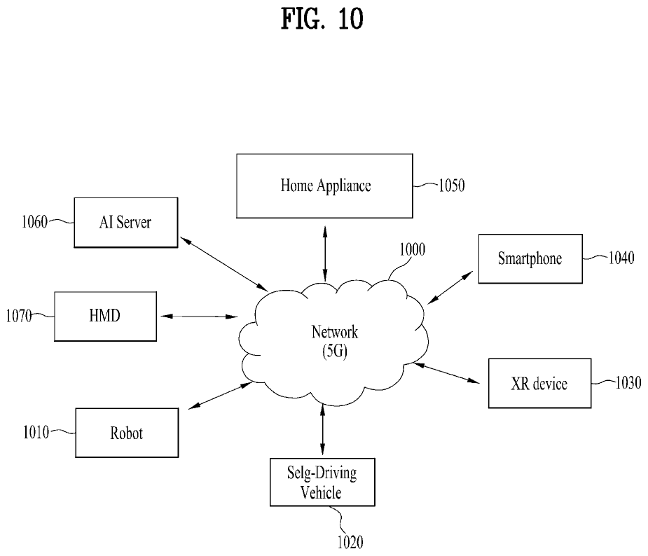

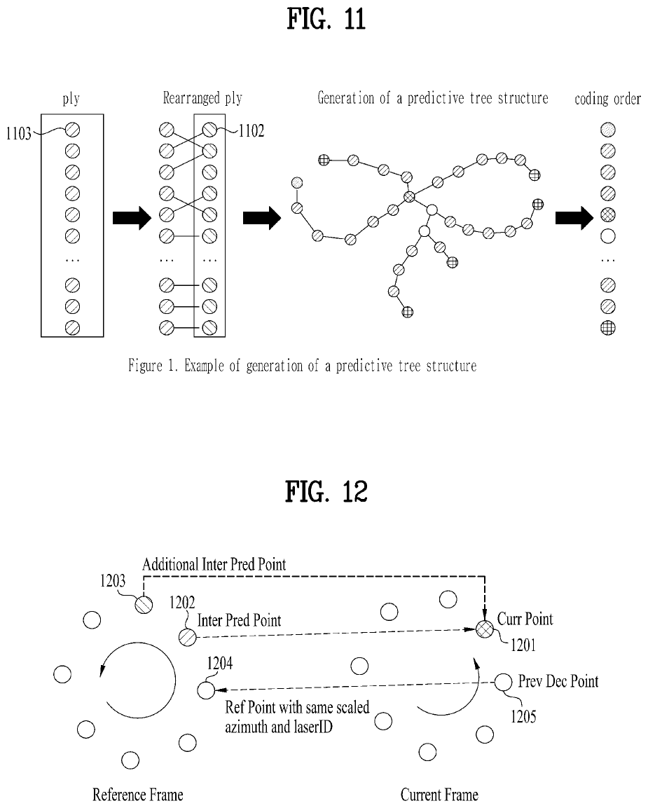

The reception device illustrated in FIG. 9 is an example of the reception device 10004 of FIG. 1 (or the point cloud decoder of FIGS. 10 and 11). The reception device illustrated in FIG. 9 may perform one or more of the operations and methods the same as or similar to those of the point cloud decoder described with reference to FIGS. 1 to 11.

The reception device according to the embodiment may include a receiver 9000, a reception processor 9001, an arithmetic decoder 9002, an occupancy code-based octree reconstruction processor 9003, a surface model processor (triangle reconstruction, up-sampling, voxelization) 9004, an inverse quantization processor 9005, a metadata parser 9006, an arithmetic decoder 9007, an inverse quantization processor 9008, a prediction/lifting/RAHT inverse transform processor 9009, a color inverse transform processor 9010, and/or a renderer 9011. Each element for decoding according to the embodiments may perform a reverse process to the operation of a corresponding element for encoding according to the embodiments.

The receiver 9000 according to the embodiments receives point cloud data. The receiver 9000 may perform an operation and/or reception method the same as or similar to the operation and/or reception method of the receiver 10005 of FIG. 1. The detailed description thereof is omitted.

The reception processor 9001 according to the embodiments may acquire a geometry bitstream and/or an attribute bitstream from the received data. The reception processor 9001 may be included in the receiver 9000.

The arithmetic decoder 9002, the occupancy code-based octree reconstruction processor 9003, the surface model processor 9004, and the inverse quantization processor 905 may perform geometry decoding. The geometry decoding according to embodiments is the same as or similar to the geometry decoding described with reference to FIGS. 1 to 10, and thus a detailed description thereof is omitted.

The arithmetic decoder 9002 according to the embodiments may decode the geometry bitstream based on arithmetic coding. The arithmetic decoder 9002 performs an operation and/or coding the same as or similar to the operation and/or coding of the arithmetic decoder 7000.

The occupancy code-based octree reconstruction processor 9003 according to the embodiments may reconstruct an octree by acquiring an occupancy code from the decoded geometry bitstream (or information about the geometry secured as a result of decoding). The occupancy code-based octree reconstruction processor 9003 performs an operation and/or method the same as or similar to the operation and/or octree generation method of the octree synthesizer 7001. When the trisoup geometry encoding is applied, the surface model processor 9004 according to the embodiments may perform trisoup geometry decoding and related geometry reconstruction (e.g., triangle reconstruction, up-sampling, voxelization) based on the surface model method. The surface model processor 9004 performs an operation the same as or similar to that of the surface approximation synthesizer 7002 and/or the geometry reconstructor 7003.

The inverse quantization processor 9005 according to the embodiments may inversely quantize the decoded geometry.

The metadata parser 9006 according to the embodiments may parse metadata contained in the received point cloud data, for example, a set value. The metadata parser 9006 may pass the metadata to geometry decoding and/or attribute decoding. The metadata is the same as that described with reference to FIG. 8, and thus a detailed description thereof is omitted.

The arithmetic decoder 9007, the inverse quantization processor 9008, the prediction/lifting/RAHT inverse transform processor 9009 and the color inverse transform processor 9010 perform attribute decoding. The attribute decoding is the same as or similar to the attribute decoding described with reference to FIGS. 1 to 10, and thus a detailed description thereof is omitted.

The arithmetic decoder 9007 according to the embodiments may decode the attribute bitstream by arithmetic coding. The arithmetic decoder 9007 may decode the attribute bitstream based on the reconstructed geometry. The arithmetic decoder 9007 performs an operation and/or coding the same as or similar to the operation and/or coding of the arithmetic decoder 7005.

The inverse quantization processor 9008 according to the embodiments may inversely quantize the decoded attribute bitstream. The inverse quantization processor 9008 performs an operation and/or method the same as or similar to the operation and/or inverse quantization method of the inverse quantizer 7006.

The prediction/lifting/RAHT inverse transform processor 9009 according to the embodiments may process the reconstructed geometry and the inversely quantized attributes. The prediction/lifting/RAHT inverse transform processor 9009 performs one or more of operations and/or decoding the same as or similar to the operations and/or decoding of the RAHT transformer 7007, the LOD generator 7008, and/or the inverse lifter 7009. The color inverse transform processor 9010 according to the embodiments performs inverse transform coding to inversely transform color values (or textures) included in the decoded attributes. The color inverse transform processor 9010 performs an operation and/or inverse transform coding the same as or similar to the operation and/or inverse transform coding of the color inverse transformer 7010. The renderer 9011 according to the embodiments may render the point cloud data.

FIG. 10 illustrates an exemplary structure operable in connection with point cloud data transmission/reception methods/devices according to embodiments.

The structure of FIG. 10 represents a configuration in which at least one of a server 1060, a robot 1010, a self-driving vehicle 1020, an XR device 1030, a smartphone 1040, a home appliance 1050, and/or a head-mount display (HMD) 1070 is connected to the cloud network 1000. The robot 1010, the self-driving vehicle 1020, the XR device 1030, the smartphone 1040, or the home appliance 1050 is called a device. Further, the XR device 1030 may correspond to a point cloud data (PCC) device according to embodiments or may be operatively connected to the PCC device.

The cloud network 1000 may represent a network that constitutes part of the cloud computing infrastructure or is present in the cloud computing infrastructure. Here, the cloud network 1000 may be configured using a 3G network, 4G or Long Term Evolution (LTE) network, or a 5G network.

The server 1060 may be connected to at least one of the robot 1010, the self-driving vehicle 1020, the XR device 1030, the smartphone 1040, the home appliance 1050, and/or the HMD 1070 over the cloud network 1000 and may assist in at least a part of the processing of the connected devices 1010 to 1070.

The HMD 1070 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1010 to 1050 to which the above-described technology is applied will be described. The devices 1010 to 1050 illustrated in FIG. 10 may be operatively connected/coupled to a point cloud data transmission device and reception device according to the above-described embodiments.

### <PCC+XR>

The XR/PCC device 1030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1030 may analyze 3D point cloud data or image data acquired through various sensors or from an external device and generate position data and attribute data about 3D points. Thereby, the XR/PCC device 1030 may acquire information about the surrounding space or a real object, and render and output an XR object. For example, the XR/PCC device 1030 may match an XR object including auxiliary information about a recognized object with the recognized object and output the matched XR object.

### <PCC+XR+Mobile Phone>

The XR/PCC device 1030 may be implemented as a mobile phone 1040 by applying PCC technology.

The mobile phone 1040 may decode and display point cloud content based on the PCC technology.

### <PCC+Self-Driving+XR>

The self-driving vehicle 1020 may be implemented as a mobile robot, a vehicle, an unmanned aerial vehicle, or the like by applying the PCC technology and the XR technology.

The self-driving vehicle 1020 to which the XR/PCC technology is applied may represent a self-driving vehicle provided with means for providing an XR image, or a self-driving vehicle that is a target of control/interaction in the XR image. In particular, the self-driving vehicle 1020 which is a target of control/interaction in the XR image may be distinguished from the XR device 1030 and may be operatively connected thereto.

The self-driving vehicle 1020 having means for providing an XR/PCC image may acquire sensor information from sensors including a camera, and output the generated XR/PCC image based on the acquired sensor information. For example, the self-driving vehicle 1020 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 1220 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image ofa real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described with reference to FIGS. 1 to 10, point cloud data is composed of a set of points, each of which may have geometry information and attribute information. The geometry information is the three-dimensional position of each point (e.g., the coordinate values of the x, y, and z axes). That is, the position of each point is indicated by parameters in a coordinate system representing a three-dimensional space (e.g., the parameters (x, y, z) of the three axes representing the space, the x, y, and z axes). The attribute information may include color (RGB, YUV, etc.), reflectance, normals, and transparency. The attribute information may be represented in the form of a scalar or vector. The geometry information may be referred to as geometry, geometry data, or a geometry bitstream. Also, the attribute information may be referred to as attributes, attribute data, or an attribute bitstream.

According to embodiments, point cloud data may be categorized into category 1 for static point cloud data, category 2 for dynamic point cloud data, and category 3 for point cloud data acquired through dynamic movement, depending on the type and acquisition method of point cloud data. Category 1 is composed of a point cloud of a single frame with a high density of points for an object or space. Category 3 data may be divided into as frame-based data with multiple frames acquired while moving, and fused data, which is a single frame matching a point cloud acquired for a large space by a LiDAR sensor with a color image acquired as a 2D image.

According to embodiments, inter-prediction (coding/decoding) may be used to efficiently compress three-dimensional point cloud data with multiple frames over time, such as frame-based point cloud data with multiple frames. Inter-prediction coding/decoding may be applied to geometry information and/or attribute information. Inter-prediction may be referred to as inter-screen prediction or inter-frame prediction, and intra-prediction may be referred to as intra-frame prediction.

According to embodiments, the point cloud data transmission/reception device/method is capable of multidirectional prediction among multiple frames. The point cloud data transmission/reception device/method may separate the coding order of the frames from the display order thereof, and predict the point cloud data according to a predetermined coding order. The point cloud data transmission/reception device/method according to the embodiments may perform inter-prediction in a predictive tree structure through references among multiple frames.

Further, according to embodiments, the point cloud data transmission/reception device/method may perform inter-prediction by generating an accumulated reference frame. The accumulated reference frame may be an accumulation of multiple reference frames.

The point cloud data transmission/reception device/method according to the embodiments may define a prediction unit to apply a technique of prediction among multiple frames as a method to increase compression efficiency of point cloud data having one or more frames. The prediction unit according to the embodiments may be referred to by various terms, such as a unit, a first unit, a region, a first region, a box, a zone, and a unit.

The point cloud data transmission/reception device/method according to the embodiments may compress/reconstruct data organized as a point cloud. Specifically, for effective compression of the point cloud having one or more frames, motion estimation and data prediction may be performed considering the capture characteristics of the point cloud captured by the LiDAR sensor and the data distribution contained in the prediction unit.

While there is active research on compression of a reference frame for inter-frame predictive tree compression, it has not yielded much performance improvement over the compression efficiency of intra-frame predictive trees. Embodiments propose a method of selecting a predictor in a predictive tree and a corresponding method to improve compression performance.

Embodiments of a transmission/reception device propose a structure allowing attribute compression to be performed based on inter-frame geometry information to compress 3D point cloud data. In point cloud data, a dynamic point cloud categorized into as Category 3 is composed of multiple point cloud frames and is primarily intended for use cases with autonomous driving data. A set of frames is called a sequence. A sequence contains frames with values of the same attribute. The attribute values have data features such as motion or changes in attribute value with respect to a previous or subsequent frame.

Therefore, in this embodiment, a structure and method for applying intra- and inter-frame features found in geometry information in attribute compression, for the purpose of compression between frames in the Category 3 sequence. Inter-frame geometry compression may be broadly divided into octree inter-frame compression and predictive tree inter-frame compression. In this embodiment, attribute compression is performed based on the information employed in predictive tree inter-frame compression. Further, for points that are not suitable in the inter-frame information attribute compression may be performed based on the intra-frame geometry information to increase the compression efficiency.

FIG. 11 illustrates a method of generating and encoding a predictive tree structure according to embodiments.

Referring to FIG. 11, the predictive tree structure according to the embodiments represents a tree structure formed of connectivity relationships between points from the x, y, and z axis coordinates of a point cloud. To construct the predictive tree, the transmission/reception device according to the embodiments sorts input points 1103 by a certain criterion and generates the predictive tree structure by calculating predicted values based on neighbor nodes (or points) from the rearranged ply (points) 1102.

The transmission/reception device according to the embodiments may rearrange the point cloud data 1103, generate a predictive tree from the rearranged point cloud data 1102 based on relationships between the points, and encode the point cloud data based on the predictive tree.

FIG. 12 illustrates inter-frame prediction according to embodiments.

The point cloud data may include multiple frames. The frames may be referred to as a group of frames (GOF). A frame that is encoded or decoded by the transmission/reception device/method according to embodiments may be referred to as a current frame, and a frame that is referenced to encode or decode the current frame may be referred to as a reference frame.

The transmission/reception device according to the embodiments may select a prediction point (inter pred point) 1202 in the reference frame to perform inter-frame predictive tree-based compression, or may use the same and an additional inter pred point 1203 as prediction points.

After compressing the geometry information, the attribute information may be compressed, in which intra-frame encoding may be performed using predicting/lifting/RAHT transform coding. Inter-frame encoding/decoding may combine the previous frame (or reference frame) and the current frame into a single frame and use Predicting/Lifting/RAHT transform coding. Regarding the transmission/reception device/method according to the embodiments, proposed herein are methods to improve performance of intra-frame coding and performance of inter-frame coding in predictive trees.

The coding order of the geometry information may be maintained or changed during compression of the attribute information. Maintaining the geometry coding order may reduce the time taken for the rearrangement at the encoder (or transmission device) and the decoder (or reception device), but may result in a lower compression rate due to the geometry coding order. If the rearrangement is performed based on a specific criterion without maintaining the geometry coding order, the execution time and memory usage for the rearrangement at the encoder and decoder may increase, but the compression rate may increase. Therefore, the time and compression rate at the encoder and decoder may determine whether to maintain the geometry coding order.

The predicting transform, lifting transform, and RAHT used to encode the attribute information in Morton order by reordering the geometry information. In predictive geometry coding, a predictive tree is formed for parent-child relationships between neighboring points, and attribute information may be encoded based on the previous point with reference to attribute values between points. Regarding the transmission/reception device according to the embodiments, a coding method for attribute information based on the predictive tree information that may be used after the predictive tree geometry coding is proposed.

The predictive geometry coding creates a parent-child relationship between nodes and calculates a predicted value for each point. The calculation of the predicted value is determined by the order of the sorted points and the position value of a close point in the order of the sorted points. The predicted value may be calculated based on the position values of the parent node and the parent-parent node with respect to the current node. Methods to calculate the predicted value in encoding based on a predictive tree include four intra-frame calculations and two inter-frame calculations.

The following are intra-frame calculation methods.
No prediction;
Delta prediction (p0);
Linear prediction (2p0−p1);
Parallelogram prediction (p0+p1−p2).

Here, “No prediction” is a method in which no prediction is used. p0 may denote the parent node (or point) for the current point in the predictive tree structure, p1 may denote the parent-parent node, and p2 may denote the parent-parent-parent node. p0, p1, and p2 may be used for prediction of the current node (or point). The parent node may be referred to as an upper node, and the child node may be referred to as a sub-node. Further, nodes may be referred to as points.

The transmission/reception device according to the embodiments may predict and encode/decode geometry information or attribute information based on the parent node, parent-parent node, and/or parent-parent-parent node in the predictive tree structure in the same frame.

The following are inter-frame calculation methods.
Inter pred point (p′0);
Additional inter pred point(p′1).

Here, inter pred point (p′0) (1202 in FIG. 12) may represent a point with the same laserID value and the most similar azimuth value in the decoded reference frame. Additional inter pred point (1203 in FIG. 12) may represent a point with a smaller azimuth value than inter pred point 1202 and the same laserID. The laserID may represent an identifier that identifies multiple laser sensors included in the LiDAR sensor.

The transmission/reception device according to the embodiments may predict and encode/decode geometry information or attribute information about the current point by referencing the inter pred point or the additional inter pred point in the reference frame. The inter pred point and the additional inter pred point in FIG. 12 may be referred to as reference points.

The order in which the geometry information is encoded based on the predictive tree is the coded order, and the decoding is performed by the decoder in the order in which the information in the coded order is received.

The transmission/reception device/method according to the embodiments provides a method for intra- and inter-frame compression using a geometry information-based predictive tree in point cloud data. A method of selecting an intra-frame prediction node is provided, and a weight calculation method may be applied to increase intra-compression performance. Also, provided herein is a method of selecting a prediction node to increase inter-compression performance. Also, a weight calculation method is provided to increase the inter-frame compression performance.

Geometry coding using a predictive tree is intra- and inter-frame coding with radius, azimuth, and laserID, but radius, azimuth, and laserID transformed into a spherical coordinate system do not reflect the characteristics of LiDAR data. The method of selecting a predictor based on a laserID cannot obtain the predictor from another laserID. The transmission/reception device/method according to the embodiments may increase intra-/inter-frame compression efficiency.

Attribute compression method using a inter-frame geometry predictive tree

The transmission/reception device/method according to the embodiments may perform geometry compression based on a predictive tree within the current frame.

Referring to FIG. 12, in inter-frame prediction, the inter-frame geometry predictive tree may select a mode according to a calculation equation by referencing up to three previously decoded points 1205 in the current frame and signal the same to the decoder. In this case, one inter pred point 1202 corresponding to the current point 1201 in the previous frame (or reference frame) may be selected as the point with the closest x, y, and z geometry values. At this time, one more point may be additionally selected in the reference frame. The inter pred point 1202 or the additional inter pred point 1203 may be selected as a candidate. One point having a smaller difference from the current point 1201 between the inter pred point 1202 and the additional inter pred point 1203 may be selected as a predictor. Based on the point selected in the reference frame, up to three previously decoded points in the reference frame may be taken as predictors to perform inter-frame geometry predictive coding.

Specifically, the inter-frame prediction (or inter-screen prediction or inter-prediction) according to the embodiments uses the frame coded immediately prior to the current frame as the reference frame, and finds a point 1204 in the reference frame that has the most similar azimuth to the point 1205 decoded prior to the current point 1201 in the current frame, and has the same laserID located at the same position. The closest point 1202 (inter pred point) or the next closest point 1203 (additional inter pred point) among the points having a greater azimuth than the found point may then be taken as a predicted value, namely, a predictor, of the current point 1201.

Regarding the transmission/reception device/method according to the embodiments, an attribute compression method using the selected inter pred point and additional inter pred point in geometry encoding is proposed. The reference point (inter pred point or additional inter pred point) selected in the reference frame may be determined as a predictor point (or predictor) or another point may be determined as a reference point. To determine the reference point, the point with the closest azimuth of the same laserID in the spherical coordinate system of (r, Φθazimuth, laserID) obtained through transformation between the current point and the predictor point may be selected as the predictor.

The transmission/reception device/method according to the embodiments may select the predictor node in the following manner.

The predictor node may be referred to as a predictor point, predictor, reference point, or neighbor node.

### 1) Matrix-Based Search Method

The transmission/reception device/method according to the embodiments may sort a 2D matrix using the radius, azimuth, and laserID. The laserID may be quantized to values from 0 to 63 or 0 to 1023. In this case, an N×M matrix may be created based on the radius and azimuth. The N×M matrix may have N rows sorted in ascending order by the radius and M columns sorted in ascending order by the azimuth. The radius and azimuth values used for sorting may be transformed to quantized values. For a 2D matrix of radius and azimuth, 2D Morton values according to laserID may be generated as indexes. In this case, the Morton indexes are ordered in the set laserID[number of lasers]={N . . . N×M}. The matrix generated by the above-described method may be ordered from 0 to N×M. The rows of the matrix are mapped to laserIDs, and the columns are listed in the order they have been generated based on the azimuth and radius.

To find a neighbor node (or predictor node) for the current point, a row with the same laserID as the current point may be searched, or the neighbor node may be searched for in the range of laserID−α to laserID+α. In this case, a may be selected as a configuration option. In a row in the range of laserID−α to laserID+α, a range that is closest to the azimuth of the current point or closest to the index generated as a 2D Morton value may be selected. This is represented as an equation.

$$P\_NN = [ ( P\_laserID - α ) , ( P\_laserID + α ) ] [ ( P\_laserID - β ) , ( P\_laserID + β ) ]$$

Current point: P
laserID of the current point: P_laserID
Morton index of the radius and azimuth of the current point: P_2DMortonIdx
Neighbor node: P_NN
laserID search range: α
Radius and azimuth search range: β

The three closest neighbors may be searched for in the set of P_NN, and p0, p1, and p2 may be selected as three predictor nodes. Based on the selected three neighbor nodes, calculations may be performed according to the No prediction, Delta prediction, Linear prediction, and Parallelogram prediction modes. This method may reduce the execution time because it does not require a predictive tree parent-child relationship to be created.

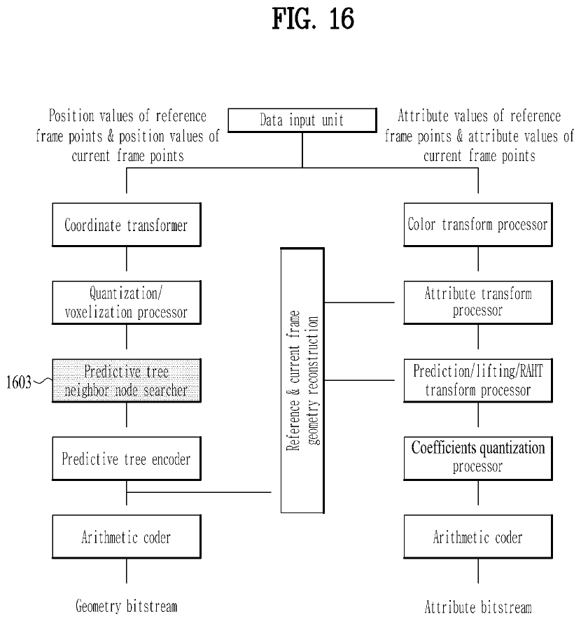

The above-described method may be carried out by the predictive tree neighbor node searcher 1603 of FIG. 16 or the predictive tree neighbor node searcher 1703 of FIG. 17.

The transmission/reception device/method according to the embodiments may generate a laserID-specific matrix from the point cloud data based on the radius and azimuth. The rows and columns of the generated matrix may be sorted by the radius and the azimuth. The 2D matrix may then be transformed into Morton indexes and sorted. Neighbor points (neighbor nodes, predictor points, or predictors, etc.) of the current point may be searched for as the points with the same laserID as the current point or with the closest azimuth or Morton index to the current point in rows with laserIDs within a specific range.

### 2) Log Map-Based Search Method (Based on Log Index)

The values of the spherical coordinates transformed to radius, azimuth, and laserID are transformed from xyz (integer type) to radius, azimuth, and laserID (float type) in precision. A higher bit precision is used in the n-bit precision range, which increases the time to search for neighbor nodes. Accordingly, an indexing method is proposed to change the precision and facilitate the search. The radius is in the range of 0 to x/2, the azimuth is in the range of −π to +π, and the laserID is in the range of 0 to 63 or 1023. In this case, the range of −π to +π of the azimuth corresponding to the laserID may be changed to a log map. The equation to change a specific value of the azimuth equal to a to an index in the log map is given as follows.

$$log Idx\_a = log\_ 2 ( a ≪ shiftBit )$$

shiftBit is an operation to increase the precision of the decimal places, and points with the azimuth mapped to the same index or a range of close indexes among the azimuths mapped to the log map index may be neighbor nodes.

The above-described method may be carried out by the predictive tree neighbor node searcher 1603 of FIG. 16 or the predictive tree neighbor node searcher 1703 of FIG. 17.

The transmission/reception device/method according to the embodiments may convert the azimuth values of the point cloud data into indexes using logarithm. Then, based on the indexes, the neighbor points (neighbor nodes, predictor points, predictors, reference points, etc.) of the current point may be searched for. That is, the transmission method according to the embodiments may search for neighbor points having indexes close to the current point based on the indexes converted using the logarithm. Then, the current point may be predicted by referencing the neighbor points.

3) Search Method Using a Representative laserID (laserID-Based Search Method)

The transmission/reception device/method according to the embodiments may search the entire set of points that have the same laserID as the current point as candidate neighbor nodes. The same laserIDs appear to be aligned in a row in flat road data.

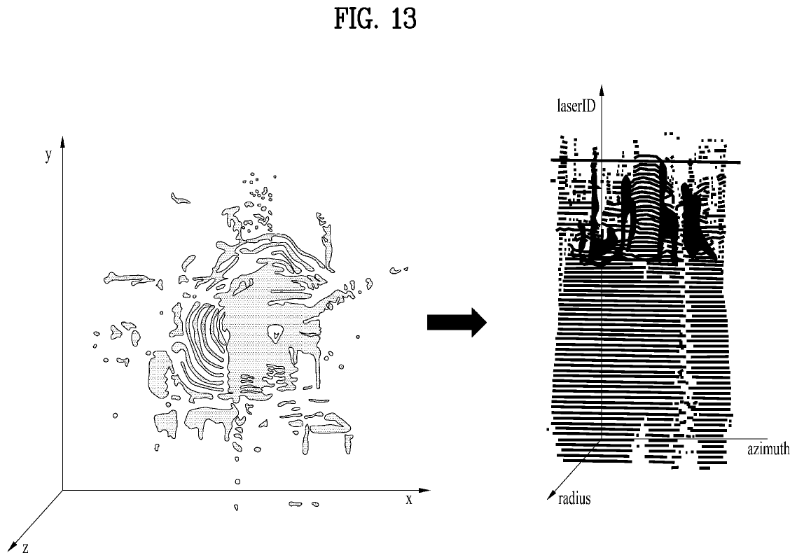

FIG. 13 illustrates point cloud data presented in a coordinate system according to embodiments.

FIG. 13 illustrates transforming point cloud data presented in the xyz coordinate system into a spherical coordinate system with azimuth/laserID/radius as the axes.

The lower part of the laserID axis represents the road portion of the point cloud, which is arranged in a row. Therefore, neighbor nodes of the road may only send the change in azimuth along the laserID as a difference value. Road data and object data may be split from the point cloud data. For the points corresponding to the road data, a point with the closest azimuth value among the points with the same laserID as the current point may be selected as a neighbor node.

Since the same road data is likely to be acquired in the previous frame even in the inter-frame prediction, the point with the same laserID and the closest azimuth in the previous frame (or reference frame) may be selected as a reference point (or neighbor point, predictor, or the like).

The method described above may be carried out by the predictive tree neighbor node searcher 1603 of FIG. 16 or the predictive tree neighbor node searcher 1703 of FIG. 17.

The transmission/reception device/method according to the embodiments may search for a neighbor point based on the laserID during neighbor point search. For example, when the current point is a road point, a point that has the closest azimuth value to the current point among the neighbor points that have the same laserID as the current point may be searched for as a neighbor point.

Road points are characterized by the presence of similar points within the same laserID that differ only in azimuth. As shown in FIG. 13, the points located at the bottom of the coordinate system consisting of the azimuth/laserID/radius axes are the points of a captured road. These road points have different azimuths within the same laserID. Therefore, when the current point is a road point, the point with the closest azimuth within the same laserID may be searched for as a neighbor point. The neighbor point may be referred to as a reference point, a predictor point, a predictor, or the like. Alternatively, it may be replaced by any other term that indicates that it is used to predict the current point.

### 4) Direction Inference Search Method Based on the Azimuth and Radius

The inter-frame inference search method based on the azimuth and radius according to laserID may include inference based on the position of the radius and the position of the azimuth.

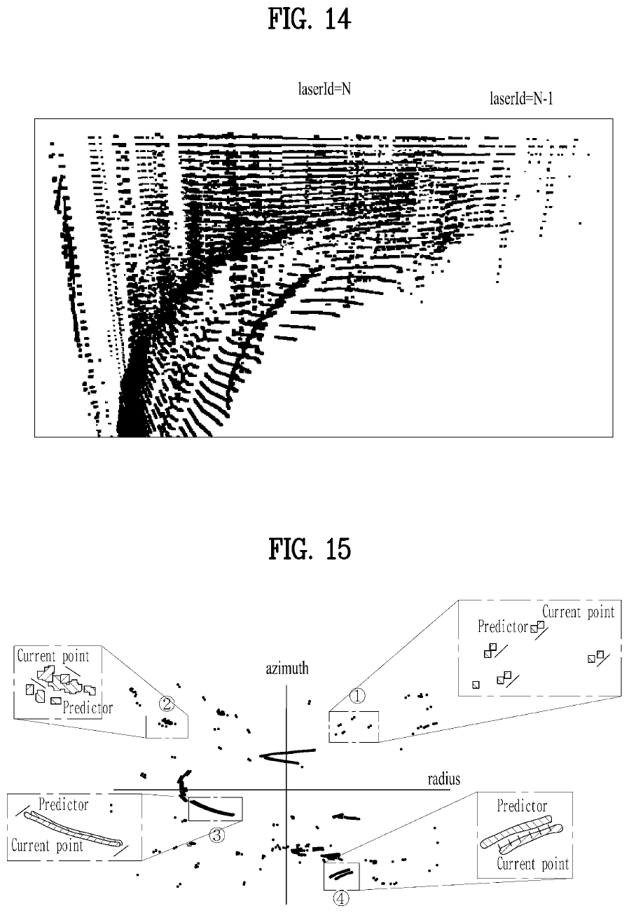

FIGS. 14 and 15 illustrate point cloud data according to embodiments.

Referring to FIGS. 14 and 15, searching for a neighbor node by inferring a search direction based on the azimuth and radius is illustrated.

In FIG. 14, the points constituting the top line have laserID=N, and the points in the line immediately below the top line have laserID=N−1. Assuming that the point to be coded (the current point) is any point among the points with laserID=N, the prediction direction may be determined according to the radius/azimuth position in order to search for a point with laserID=N−1 as a candidate neighbor that is a point in the frame.

Referring to FIG. 15, the direction in which a predictor is searched for based on the current point is indicated by arrows. In the quadrants configured with the radius axis and the azimuth axis, the direction of searching for a predictor may be determined based on the region of the quadrant in which the current point is located. In FIG. 15, the zoomed-in regions represent the current point and predictors (or neighbors), and arrows indicate the direction in which predictors are searched for based on the current point. In FIG. 15, multiple points are overlaid to form a single geometric shape, which may be understood as representing points overlapping each other.

In FIG. 15, in the radius/azimuth plan view, in the case where the current point is in the first quadrant, neighbor nodes (or predictors) are searched for based on the lower_bound of the radius and the lower_bound of the azimuth. In the case where the current point is in the second quadrant, neighbor nodes are searched for based on the upper_bound of the radius and the lower_bound of the azimuth. In the case where the current point is in the third quadrant, neighbor nodes may be searched for based on the upper_bound of the radius and the upper_bound of the azimuth. In the case where the current point is in the fourth quadrant, neighbor nodes may be searched for based on the lower_bound of the radius and the upper_bound of the azimuth.

Upper_bound may be referred to as an upper bound and lower_bound as a lower bound. Searching for a neighbor point based on the upper bound may mean searching for a neighbor point having a greater value than the current point, and searching for a neighbor point based on the lower bound may mean searching for a neighbor having a less value than the current point.

The pseudo code for the direction inference method is shown below.

```
  if (radius > 0 && azimuth > 0) // A condition for selecting a predictor in the first region
(first quadrant)
  lower_bound(point[0]), lower_bound(point[1]) // point[0] denotes the radius of the
current point, and point[1] denotes the azimuth of the current point. That is, prediction is
performed based on the lower_bound of the radius and azimuth of the current point (in the
negative direction).
  else if(radius < 0 && azimuth > 0) // A condition for selecting a predictor in the second
quadrant
  upper_bound(point[0]), lower_bound(point[1])
  // Prediction is performed based on the upper_bound of the radius of the current point (in
the positive direction) and the lower_bound of the azimuth of the current point (in the negative
direction).
  else if(radius < 0 && azimuth < 0) // A condition for selecting a predictor in the third
quadrant
  upper_bound(point[0]), upper_bound(point[1])
  // Prediction is performed based on the upper_bound of the radius of the current point (in
the positive direction) and the upper_bound of the azimuth of the current point (in the positive
direction).
  else // A condition for selecting a predictor in the fouth region (fourth quadrant)
  lower_bound(point[0]), upper_bound(point[1]) // Prediction is performed based on the
lower_bound of the radius of the current point (in the negative direction) and the upper_bound of
the azimuth of the current point (in the positive direction).
```

The transmission/reception device/method according to the embodiments may apply the direction inference method based on the azimuth and radius at the same laserID in the reference frame during inter-frame compression.

For the selected predictor, the encoder signals the mode and residual. When the azimuth and radius of the current point are in the fourth quadrant, prediction of the predictor in the upper/lower direction may be indirectly identified. The decoding may be performed by the decoder in the same manner. The decoder may predict the original points in order of the points selected as predictors. The decoding may be performed by computing the residual of the original point based on N modes and the predictor, where N is the number of points in the point selected as the predictor.

The above-described method may be carried out by the predictive tree neighbor node searcher 1603 of FIG. 16 or the predictive tree neighbor node searcher 1703 of FIG. 17.

The transmission/reception device/method according to the embodiments may have different search directions for neighbor points based on the radius and azimuth of the current point. More specifically, the search direction of the neighbor points may be determined based on the region in which the current point is located in the quadrant composed of the radius axis and the azimuth axis.

For example, in the case where the radius and azimuth of the current point are in the first quadrant (radius>0, azimuth>0), a point having a radius and azimuth less than the radius and azimuth of the current point may be searched for as a neighbor point. In the case where the radius and azimuth of the current point are in the second quadrant (radius<0, azimuth>0), a point having a radius greater than the radius of the current point and an azimuth less than the azimuth of the current point may be searched for as a neighbor point. In the case where the radius and azimuth of the current point are in the third quadrant (radius<0, azimuth<0), a point having a radius greater than the radius of the current point and an azimuth greater than the azimuth of the current point may be searched for as a neighbor point. In the case where the radius and azimuth of the current point are in the fourth quadrant (radius>0, azimuth<0), a point having a radius less than the radius of the current point and an azimuth greater than the azimuth of the current point may be searched for as a neighbor point. In other words, depending on the quadrant in which the current point is located, the neighbor point may be searched for based on the upper bound or lower bound of the values of the current point.

### 5) Weight Calculation Method for a Predictor Node

The transmission/reception device/method according to the embodiments may calculate a weight for a candidate selected as a predictor node. The weight is a value that compensates for different precisions of the radius/azimuth/laserID to calculate the Euclidean distance. Different weights may be applied to the radius/azimuth/laserID, respectively, or no weight may be applied. The weights calculated by the transmission device are transmitted to the reception device, which applies the same weights. In inter-frame prediction, the same weight values applied to the previous frame may be applied to the current frame.

FIG. 16 illustrates a point cloud data transmission device according to embodiments.

The point cloud data transmission device according to the embodiments may correspond to the transmission device of FIG. 1, the transmission device of FIG. 3, the transmission device of FIG. 8, the devices of FIG. 10, and/or the point cloud data transmission device of FIG. 16. Further, the transmission device may include a combination of the components illustrated in the figures described above.

The point cloud data transmission device according to the embodiments includes a predictive tree neighbor node searcher 1603.

In compressing geometry information using a predictive tree, the predictive tree neighbor node searcher 1603 may generate and signal information about the search method (predtree_NN_method) (0=matrix-based search, 1=log index-based search, 2=representative laserID-based search, 3=direction inference search based on azimuth and radius, 4=other methods).

The information about the neighbor node search method (predtree_NN_method) according to the embodiments may be used in parallel with a conventional neighbor node search method, and the proposed methods described above may be used only for the last point for the laserID. In this case, when another neighbor node search method is used for the last point for the laserID, information about whether it is used (laserID_last_point_NN_search_flag) and information about how to use the method may be generated and signaled.

In addition, when there are weight values used in the neighbor node calculation, the predictive tree neighbor node searcher 1603 may signal weight information (NN_weight).

FIG. 17 illustrates a point cloud data reception device according to embodiments.

The point cloud data reception device according to the embodiments may correspond to the reception device of FIG. 1, the decoder of FIG. 7, the reception device of FIG. 9, the devices of FIG. 10, and/or the point cloud data reception device of FIG. 17. Further, the reception device may include a combination of the components illustrated in the figures described above.

The reception device according to the embodiments may include a predictive tree neighbor node searcher 1703.

In decoding geometry information using a predictive tree, the predictive tree neighbor node searcher 1703 may receive information about a search method (predtree_NN_method) (0=matrix-based search, 1=log index-based search, 2=representative laserID-based search, 3=direction inference search based on azimuth and radius, 4=other methods).

The information about the neighbor node search method (predtree_NN_method) according to the embodiments may be used in parallel with a conventional neighbor node search method, and the proposed methods described above may be used only for the last point for the laserID. In this case, when another neighbor node search method is used for the last point for the laserID, information about whether it is used (laserID_last_point_NN_search_flag) and information about how to use the method may be received.

When there are weight values used in the neighbor node calculation, the reception device according to the embodiments may receive the weight information (NN_weight) from the predictive tree neighbor node searcher 1703 and apply the same to the predictor node.

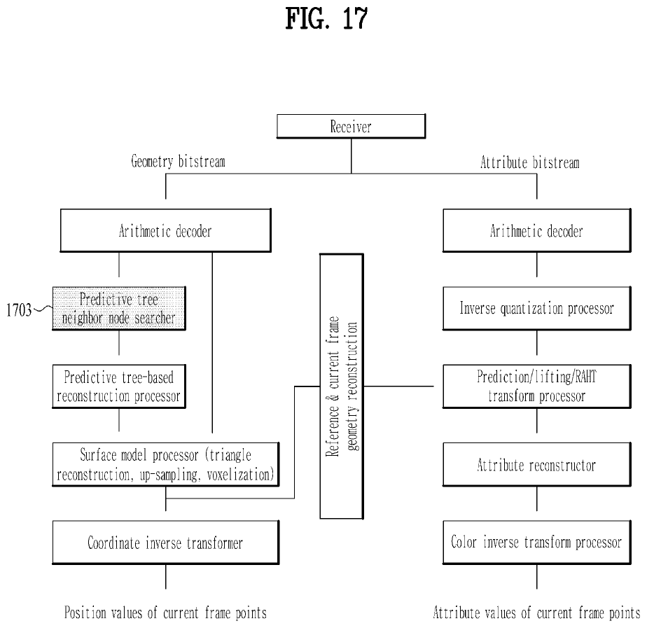

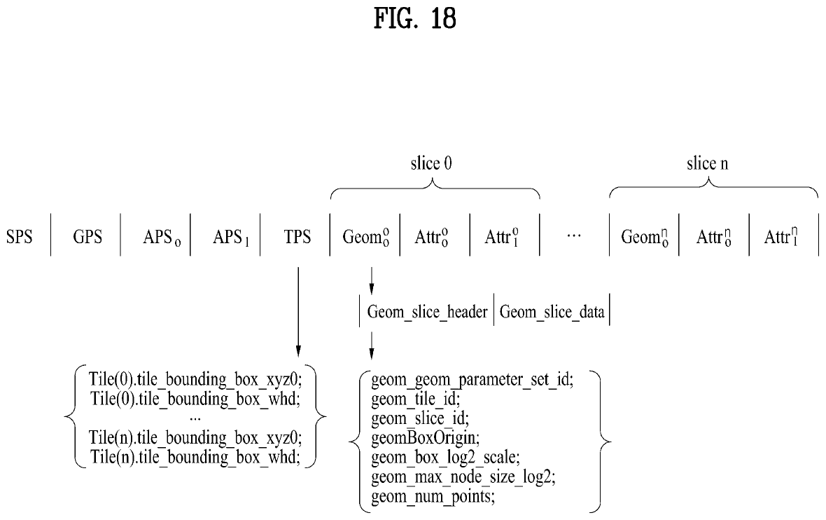

FIG. 18 illustrates an encoded bitstream according to embodiments.

The bitstream according to the embodiments may be transmitted based on the transmission device 10000 of FIG. 1, the transmission method of FIG. 2, the encoder of FIG. 3, the transmission device of FIG. 8, the devices of FIG. 10, the transmission device of FIG. 16, and the transmission method of FIG. 24. Further, the bitstream according to the embodiments may be received based on the reception device 20000 of FIG. 1, the reception method of FIG. 2, the reception device of FIG. 7, the devices of FIG. 10, the reception device of FIG. 17, and the reception method of FIG. 25.

The transmission/reception method/device according to the embodiments may signal neighbor node (or predictor) search-related information. That is, the transmission/reception method/device according to the embodiments may signal the information to add/carry out an intra-/inter-frame encoding/decoding method using a predictive tree neighbor search.

Parameters (which may be referred to as metadata, signaling information, or the like) according to embodiments may be generated in a process of the transmitter according to embodiments described below and may be delivered to the receiver according to embodiments so as to be used in a process of reconstructing point cloud data. For example, the parameters according to the embodiments may be generated by the metadata processor (or metadata generator) of the transmission device according to embodiments described below and acquired by the metadata parser of the reception device according to embodiments described below.

In FIG. 18, each abbreviation means the following.
SPS: Sequence Parameter Set
GPS: Geometry Parameter Set
APS: Attribute Parameter Set
TPS: Tile Parameter Set
Geom: Geometry bitstream=geometry slice header+geometry slice data
Attr: Attribute bitstream=attribute slice header+attribute slice data

A slice according to embodiments may be referred to as a data unit. The slice header may be referred to as a data unit header. In addition, slices may be referred to by other terms having similar meanings, such as bricks, boxes, and regions.

The bitstream according to embodiments may provide tiles or slices to allow the point cloud to be divided into regions for processing. When the point cloud is divided into regions, each region may have a different importance. The transmission and reception devices according to embodiments may provide different filters or different filter units to be applied based on the importance, thereby providing a method to use a more complex filtering method with higher quality results for important regions. In addition, by allowing different filtering to be applied to each region (region divided into tiles or slices) depending on the processing capacity of the reception device, instead of using a complicated filtering method for the entire point cloud, better image quality may be ensured for regions that are important to the user and appropriate latency may be ensured for the system. When the point cloud is divided into tiles, different filters or different filter units may be applied to the respective tiles. When the point cloud is divided into slices, different filters or different filter units may be applied to the respective slices. The attribute-based-predictive tree encoding/decoding method may be applied to each parameter set and signaled.

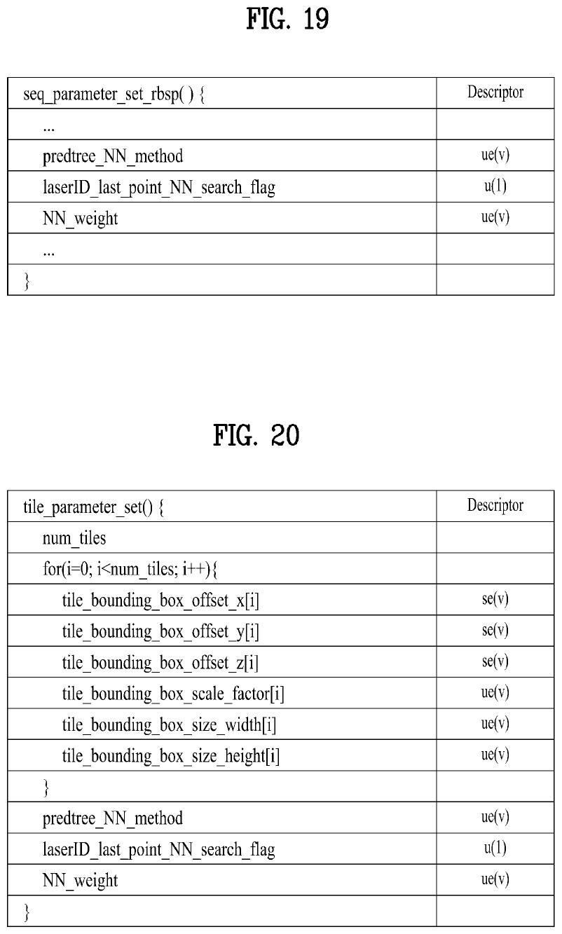

FIG. 19 illustrates a syntax of a sequence parameter set (seq_parameter_set) according to embodiments.

The sequence parameter set may further contain related syntax information for predictor or neighbor node search. The syntax information may be signaled.

predtree_NN_method may indicate a search method used by the predictive tree neighbor node searcher in compressing geometry using a predictive tree. (0=matrix-based search, 1=log map-based search, 2=representative laserID-based search, 3=direction inference search based on azimuth and radius, 4=other methods).

laserID_last_point_NN_search_flag indicates whether to use the method carried out by the predictive tree neighbor node searcher according to the embodiments only for the last point for the laserID.

NN_weight may indicate weight information used in the neighbor node calculation by the predictive tree neighbor node searcher according to the embodiments.

FIG. 20 illustrates a syntax of a tile parameter set (tile_parameter_set) according to embodiments.

The tile parameter set may further contain related syntax information for predictor or neighbor node search. The syntax information may be signaled.

predtree_NN_method may indicate a search method used by the predictive tree neighbor node searcher in compressing geometry using a predictive tree. (0=matrix-based search, 1=log map-based search, 2=representative laserID-based search, 3=direction inference search based on azimuth and radius, 4=other methods).

laserID_last_point_NN_search_flag indicates whether to use the method carried out by the predictive tree neighbor node searcher according to the embodiments only for the last point for the laserID.

NN_weight may indicate weight information used in the neighbor node calculation by the predictive tree neighbor node searcher according to the embodiments.

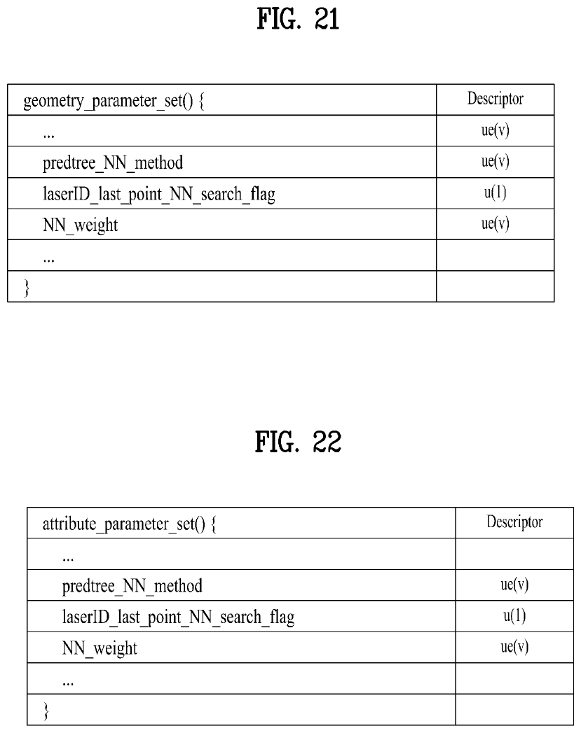

FIG. 21 illustrates a syntax of a geometry parameter set (geometry_parameter_set) according to embodiments.

The geometry parameter set may further contain related syntax information for predictor or neighbor node search. The syntax information may be signaled.

predtree_NN_method may indicate a search method used by the predictive tree neighbor node searcher in compressing geometry using a predictive tree. (0=matrix-based search, 1=log map-based search, 2=representative laserID-based search, 3=direction inference search based on azimuth and radius, 4=other methods).

laserID_last_point_NN_search_flag indicates whether to use the method carried out by the predictive tree neighbor node searcher according to the embodiments only for the last point for the laserID.

NN_weight may indicate weight information used in the neighbor node calculation by the predictive tree neighbor node searcher according to the embodiments.

FIG. 22 illustrates a syntax of an attribute parameter set (attribute_parameter_set) according to embodiments.

The attribute parameter set may further contain related syntax information for predictor or neighbor node search. The syntax information may be signaled.

predtree_NN_method may indicate a search method used by the predictive tree neighbor node searcher in compressing geometry using a predictive tree. (0=matrix-based search, 1=log map-based search, 2=representative laserID-based search, 3=direction inference search based on azimuth and radius, 4=other methods).

laserID_last_point_NN_search_flag indicates whether to use the method carried out by the predictive tree neighbor node searcher according to the embodiments only for the last point for the laserID.

NN_weight may indicate weight information used in the neighbor node calculation by the predictive tree neighbor node searcher according to the embodiments.

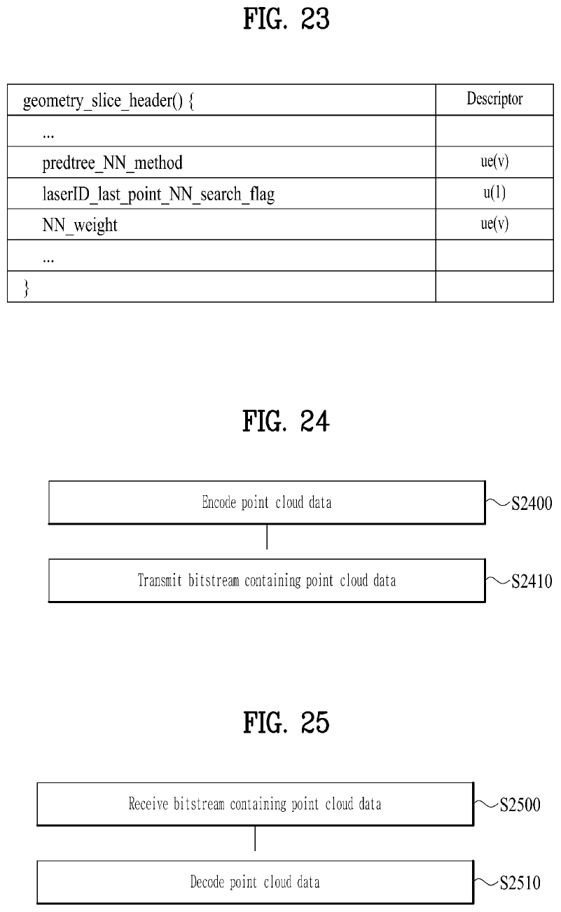

FIG. 23 illustrates a syntax of a geometry slice header (geometry_slice_header) according to embodiments.

The geometry slice header may further contain related syntax information for predictor or neighbor node search. The syntax information may be signaled.

predtree_NN_method may indicate a search method used by the predictive tree neighbor node searcher in compressing geometry using a predictive tree. (0=matrix-based search, 1=log map-based search, 2=representative laserID-based search, 3=direction inference search based on azimuth and radius, 4=other methods).

laserID_last_point_NN_search_flag indicates whether to use the method carried out by the predictive tree neighbor node searcher according to the embodiments only for the last point for the laserID.

NN_weight may indicate weight information used in the neighbor node calculation by the predictive tree neighbor node searcher according to the embodiments.

FIG. 24 illustrates a transmission method according to embodiments.

The transmission method of FIG. 24 may be carried out by the transmission device of FIG. 1, the transmission of FIG. 2, the point cloud encoder of FIG. 3, the transmission device of FIG. 8, the devices of FIG. 10, and/or the transmission method/device described by FIG. 16, or may correspond to or be combined with the embodiments described in each of the figures.

The transmission method of FIG. 24 includes encoding point cloud data (S2400), transmitting a bitstream containing the point cloud data (S2410).

Operation S2400 of encoding the point cloud data may include searching for a neighbor point of the current point and predicting the current point based on the found neighbor point.

The neighbor point may be referred to as a neighbor node, a predictor, or the like. In other words, it may represent a point close to the original point that is used to predict the original point, and may be replaced by other terms with similar meaning. The original point may be predicted based on the found neighbor points, and the difference between the predicted value and the value of the original point may be encoded as a residual.

The operation of searching for the neighbor point may be performed by the predictive tree neighbor node searcher 1603 of FIG. 16, and the predictive tree encoder of FIG. 16 may encode the residual between the predicted value and the value of the original point.

The operation of searching for the neighbor point may include searching for the neighbor point based on a matrix. The operation of searching for the neighbor point may further include generating a matrix based on a radius and an azimuth for each laserID, wherein rows or columns of the matrix may be sorted based on values of the radius or the azimuth. 2D matrices composed of the radius and the azimuth may be generated as many as laserIDs. Further, Morton indexes may be generated based on the matrix and the matrix may be sorted based on the Morton indexes. In searching for the neighbor point, a laserID that is the same as the laserID of the current point may be searched for, and then a point having the closest radius or azimuth or the closest Morton index to the current point may be searched for. Alternatively, matrices corresponding to laserIDs within a predetermined range from the laserID of the current point may be searched for a point having the closest radius or azimuth or the closest Morton index.

The operation of searching for the neighbor point may further include generating a matrix based on at least one of the radius or the azimuth for each laserID, wherein rows or columns of the matrix may be sorted based on a value of at least one of the radius or the azimuth. That is, the matrix may be generated based on both the radius and the azimuth, or based on one of the radius and the azimuth, and the rows or columns may be sorted.

Further, the operation of searching for the neighbor point may include searching for the neighbor point using a log. The operation of searching for the neighbor point may further include converting a value of the azimuth into an index using the log, and searching for the neighbor point based on the index. The equation to change a specific value of the azimuth equal to a to an index in the log map is given as follows.

$$log Idx\_a = log\_ 2 ( a ≪ shiftBit )$$

The transmission method according to the embodiments may search for a neighbor point having an index close to that of the current point based on the index obtained by conversion using the log.

Further, the operation of searching for the neighbor point may include searching for the neighbor point based on laserID. For example, when the current point is a road point, a point having a closest value of the azimuth to the current point may be searched for as the neighbor point among the points having the same laserID as the current point. Related details are described with reference to FIG. 13.

Furthermore, the operation of searching for the neighbor point may be performed in a different search direction of the neighbor point based on the values of the radius and azimuth of the current point. More specifically, the search direction of the neighbor point may be determined based on a region containing the current point in a quadrant composed of an axis of the radius and an axis of the azimuth.

For example, in the case where the radius and azimuth of the current point are in the first quadrant (radius>0, azimuth>0), a point having a radius and azimuth less than the radius and azimuth of the current point may be searched for as a neighbor point. In the case where the radius and azimuth of the current point are in the second quadrant (radius<0, azimuth>0), a point having a radius greater than the radius of the current point and an azimuth less than the azimuth of the current point may be searched for as a neighbor point. In the case where the radius and azimuth of the current point are in the third quadrant (radius<0, azimuth<0), a point having a radius greater than the radius of the current point and an azimuth greater than the azimuth of the current point may be searched for as a neighbor point. In the case where the radius and azimuth of the current point are in the fourth quadrant (radius>0, azimuth<0), a point having a radius less than the radius of the current point and an azimuth greater than the azimuth of the current point may be searched for as a neighbor point. Related details are described with reference to FIG. 15.

In operation S2410 of transmitting the bitstream, the bitstream may contain information (predtree_NN_method) indicating a search method for the neighbor point and information (NN_weight) indicating a weight used for the neighbor point. The information may be delivered to a reception device according to embodiments, which may search for the neighbor point and apply a weight based on the information.

The transmission method according to the embodiments may be carried out by a transmission device according to embodiments. The transmission device according to the embodiments includes an encoder configured to encode point cloud data and a transmitter configured to transmit a bitstream containing the point cloud data.

The encoder and transmitter according to the embodiments may correspond to or be combined with the transmission device of FIG. 1, the transmission of FIG. 2, the point cloud encoder of FIG. 3, the transmission device of FIG. 8, the devices of FIG. 10, the transmission device of FIG. 16, and/or the transmission device/method described by FIG. 24. The transmission device according to the embodiments may be represented by a device including as a component a unit, module, or processor configured to perform the processing of the aforementioned transmission method.

The encoder and transmitter according to the embodiments may include a processor and a memory as components that perform the processing of the aforementioned transmission method. The memory may store instructions causing the processor to perform operations.

FIG. 25 illustrates a reception method according to embodiments.

The reception method/device of FIG. 25 may be carried out by the reception device of FIG. 1, the reception of FIG. 2, the point cloud decoder of FIG. 7, the reception device of FIG. 9, the devices of FIG. 10, and/or the reception method/device described in FIG. 17, or may correspond to or be combined with the embodiments described in each figure.

Referring to FIG. 25, the reception method according to the embodiments includes receiving a bitstream containing point cloud data (S2500) and decoding the point cloud data (S2510). The reception method according to the embodiments may correspond to a reverse process to the transmission method according to FIG. 24.

Operation S2510 of decoding the point cloud data includes searching for a neighbor point of the current point and predicting the current point based on the found neighbor point.

The neighbor point may be referred to as a neighbor node, a predictor, or the like. In other words, the neighbor point may represent a point close to the original point that is used to predict the original point, and may be replaced by other terms with similar meaning. The original point may be predicted based on the found neighbor points, and the difference between the predicted value and the value of the original point may be encoded as a residual.

The reception method according to the embodiments may reconstruct the original point by adding the predicted value of the original point and the decoded residual.

The operation of searching for the neighbor point may be performed by the predictive tree neighbor node searcher 1703 of FIG. 17, and the predictive tree-based reconstruction processor of FIG. 17 may reconstruct the original point by summing the predicted value and the residual.

The operation of searching for the neighbor point may include searching for the neighbor point based on a matrix. The operation of searching for the neighbor point may further include generating a matrix based on a radius and an azimuth for each laserID, wherein rows or columns of the matrix may be sorted based on values of the radius or the azimuth. 2D matrices composed of the radius and the azimuth may be generated as many as laserIDs. Further, Morton indexes may be generated based on the matrix and the matrix may be sorted based on the Morton indexes. In searching for the neighbor point, a laserID that is the same as the laserID of the current point may be searched for, and then a point having the closest radius or azimuth or the closest Morton index to the current point may be searched for. Alternatively, matrices corresponding to laserIDs within a predetermined range from the laserID of the current point may be searched for a point having the closest radius or azimuth or the closest Morton index.

The operation of searching for the neighbor point may further include generating a matrix based on at least one of the radius or the azimuth for each laserID, wherein rows or columns of the matrix may be sorted based on a value of at least one of the radius or the azimuth. That is, the matrix may be generated based on both the radius and the azimuth, or based on one of the radius and the azimuth, and the rows or columns may be sorted.

Further, the operation of searching for the neighbor point may include searching for the neighbor point using a log. The operation of searching for the neighbor point may further include converting a value of the azimuth into an index using the log, and searching for the neighbor point based on the index. The equation to change a specific value of the azimuth equal to a to an index in the log map is given as follows.

$$log Idx\_a = log\_ 2 ( a ≪ shiftBit )$$

The reception method according to the embodiments may search for a neighbor point having an index close to that of the current point based on the index obtained by conversion using the log.

Further, the operation of searching for the neighbor point may include searching for the neighbor point based on laserID. For example, when the current point is a road point, a point having a closest value of the azimuth to the current point may be searched for as the neighbor point among the points having the same laserID as the current point. Related details are described with reference to FIG. 13.

Furthermore, the operation of searching for the neighbor point may be performed in a different search direction of the neighbor point based on the values of the radius and azimuth of the current point. More specifically, the search direction of the neighbor point may be determined based on a region containing the current point in a quadrant composed of an axis of the radius and an axis of the azimuth.

For example, in the case where the radius and azimuth of the current point are in the first quadrant (radius>0, azimuth>0), a point having a radius and azimuth less than the radius and azimuth of the current point may be searched for as a neighbor point. In the case where the radius and azimuth of the current point are in the second quadrant (radius<0, azimuth>0), a point having a radius greater than the radius of the current point and an azimuth less than the azimuth of the current point may be searched for as a neighbor point. In the case where the radius and azimuth of the current point are in the third quadrant (radius<0, azimuth<0), a point having a radius greater than the radius of the current point and an azimuth greater than the azimuth of the current point may be searched for as a neighbor point. In the case where the radius and azimuth of the current point are in the fourth quadrant (radius>0, azimuth<0), a point having a radius less than the radius of the current point and an azimuth greater than the azimuth of the current point may be searched for as a neighbor point. Related details are described with reference to FIG. 15.

In operation S2500 of receiving the bitstream, the bitstream may contain information (predtree_NN_method) indicating a search method for the neighbor point and information (NN_weight) indicating a weight used for the neighbor point. The information may be received from the transmission device according to the embodiments, and the reception device according to the embodiments may search for the neighbor point and apply a weight based on the information.

The reception method according to the embodiments may be carried out by a reception device according to embodiments. The reception device according to the embodiments includes a receiver configured to receive a bitstream containing point cloud data and a decoder configured to decode the point cloud data. The reception device according to the embodiments may include as a component a unit, module, or processor configured to perform the processing of the aforementioned reception method.

The receiver and decoder according to the embodiments may correspond to or be combined with the reception device of FIG. 1, the reception of FIG. 2, the point cloud decoder of FIG. 7, the reception device of FIG. 9, the devices of FIG. 10, and the reception device described in FIG. 17.

The receiver and decoder according to the embodiments may include a processor and a memory as components that perform the aforementioned reception method. The memory may store instructions causing the processor to perform operations.

The transmission/reception device/method according to the embodiments provides a method to improve geometry predictive tree coding performance for point cloud compression. An intra-/inter-frame predictor node search method is presented to find candidates that cannot be found with a predictor node in the conventional technology. By utilizing the characteristics of laserID within frames and data using the same laserID between frames, search performance may be improved and complexity required for 3D sorting by the encoder/decoder may be reduced.

The transmission and reception operations according to the embodiments may be performed by the transmission device and/or the reception device according to the embodiments. The transmission/reception device may include a transmitter/receiver configured to transmit/receive media data, a memory configured to store instructions (program code, algorithms, flowcharts, and/or data) for the operations according to the embodiments, and a processor configured to control the operations of the transmission/reception device.

The transmission/reception device/method according to the embodiments analyzes the relationship between points and organizes a list of core points to perform operations based on the core points included in the list in performing inter-prediction. Accordingly, the accuracy of predicting the remaining points may be improved and the residual may be reduced. Further, the decoding does not require additional time to build a mapping list, and thus the decoding time may be reduced. The core points extracted by clustering according to embodiments may be utilized as additional information in analyzing the relationship between frames during inter-frame prediction (inter-prediction).

The operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The embodiments have been described in terms of a method and/or a device, and the description of the method and the description of the device may be applied complementary to each other.

Although the accompanying drawings have been described separately for simplicity, it is possible to design new embodiments by combining the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same.

Executable instructions for performing the method/operations of the device according to the embodiments may be stored in a non-transitory CRM or other computer program products configured to be executed by one or more processors, or may be stored in a transitory CRM or other computer program products configured to be executed by one or more processors.

In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In the present disclosure, “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to perform the related operation or interpret the related definition according to a specific condition when the specific condition is satisfied.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

### MODE FOR DISCLOSURE

As described above, related details have been described in the best mode for carrying out the embodiments.

### INDUSTRIAL APPLICABILITY

As described above, the embodiments are fully or partially applicable to a point cloud data transmission/reception device and system. Those skilled in the art may change or modify the embodiments in various ways within the scope of the embodiments. Embodiments may include variations/modifications within the scope of the claims and their equivalents.

1. A method of transmitting point cloud data, the method comprising:
encoding point cloud data; and
transmitting a bitstream containing the point cloud data.

2. The method of claim 1, wherein the encoding of the point cloud data comprises:
searching for a neighbor point of a current point; and
predicting the current point based on the found neighbor point.

3. The method of claim 2, wherein the searching for the neighbor point comprises:
generating a matrix based on at least one of a radius or an azimuth for each laserID,
wherein rows or columns of the matrix are sorted based on a value of at least one of the radius or the azimuth.

4. The method of claim 2, wherein the searching for the neighbor point comprises:
converting a value of an azimuth of the point cloud data into an index using a log; and
searching for the neighbor point based on the index.

5. The method of claim 2, wherein the searching for the neighbor point comprises:
based on the current point being a road point, searching for a point having a closest value of an azimuth to the current point as the neighbor point among points having the same laserID as the current point,
wherein the searching for the neighbor point is performed in a different search direction of the neighbor point based on at least one of a value of a radius or a value of an azimuth of the current point.

6. (canceled)

7. The method of claim 2, wherein the searching for the neighbor point comprises:
determining the search direction of the neighbor point based on a region containing the current point in a quadrant composed of an axis of the radius and an axis of the azimuth,
wherein the bitstream contains information indicating a search method for the neighbor point and information indicating a weight used for the neighbor point.

8. (canceled)

9. A device for transmitting point cloud data, comprising:
an encoder configured to encode point cloud data; and
a transmitter configured to transmit a bitstream containing the point cloud data.

10. A method of receiving point cloud data, the method comprising:
receiving a bitstream containing point cloud data; and
decoding the point cloud data.

11. The method of claim 10, wherein the decoding comprises:
searching for a neighbor point of a current point; and
predicting the current point based on the found neighbor point.

12. The method of claim 11, wherein the searching for the neighbor point comprises:
generating a matrix based on at least one of a radius or an azimuth for each laserID,
wherein rows or columns of the matrix are sorted based on a value of at least one of the radius or the azimuth.

13. The method of claim 11, wherein the searching for the neighbor point comprises:
converting a value of an azimuth into an index using a log; and
searching for the neighbor point based on the index.

14. The method of claim 11, wherein the searching for the neighbor point comprises:
based on the current point being a road point, searching for a point having a closest value of an azimuth to the current point as the neighbor point among points having the same laserID as the current point,
wherein the searching for the neighbor point comprises:
searching for the neighbor point in a different direction based on at least one of a value of a radius or a value of an azimuth of the current point.

15. (canceled)

16. The method of claim 11, wherein the searching for the neighbor point comprises:
determining a direction of searching for the neighbor point based on a region containing the current point in a quadrant composed of an axis of the radius and an axis of the azimuth.

17. The method of claim 11, wherein the bitstream contains information indicating a search method for the neighbor point and information indicating a weight used for the neighbor point.

18. A device for receiving point cloud data, comprising:
a receiver configured to receive a bitstream containing point cloud data; and
a decoder configured to decode the point cloud data.
